(19) United States
(12) Patent Application Publication
(10) Pub. No.: US 2025/0335925 A1
(43) Pub. Date: Oct. 30, 2025

(54) Asset Recovery System for Self-Service Market Environments

(71) Applicant: 365 Retail Markets, LLC, Troy, MI (US)

(72) Inventors: Boris Amegadjie, Chicago, IL (US); William Kolpasky, Grosse Pointe Woods, MI (US); Ryan McWhirter, Saint Clair Shores, MI (US)

(21) Appl. No.: 18/647,417

(22) Filed: Apr. 26, 2024

(51) Int. Cl. G06Q 20/38; G06Q 20/18; G06Q 20/40

(52) U.S. Cl. CPC G06Q 20/42; G06Q 20/18; G06Q 20/389; G06Q 20/401

(57) ABSTRACT

A computing device may receive an indication associated with an asset conversion failure incident. The asset conversion failure incident may include a failure of a user of the self-service retail market environment to complete a transaction for a retrieved inventory asset. The computing device may identify the user based on the indication associated with the asset conversion failure incident and generate an incident report corresponding to the asset conversion failure incident. The computing device may transmit the incident report to a user mobile device associated with the user. The incident report may include an asset recovery mechanism associated with an asset recovery operation.

### TECHNICAL FIELD

This disclosure relates to an asset recovery system for self-service market environments.

### BACKGROUND

Connected systems are used to facilitate transactions, such as by transmitting, receiving, and processing requests. In one example, a connected system can include devices within a self-service market environment. A person may use such a device to initiate, process, and complete a transaction. In some cases, the self-service market device may verify information about the person before determining whether to allow the transaction. A self-service market environment may be monitored to ensure conversion of assets from inventory assets to monetary assets.

### SUMMARY

Disclosed herein are, inter alia, implementations of systems and techniques for asset recovery associated with a self-service retail market.

Some implementations described herein relate to an apparatus for asset recovery in association with a self-service retail market environment. The apparatus includes a memory and a processor coupled with the memory. The memory includes computer-executable instructions, and the processor is configured to execute the computer-executable instructions to cause the apparatus to receive an indication associated with an asset conversion failure incident. The asset conversion failure incident may include a failure of a user of the self-service retail market environment to complete a transaction for a retrieved inventory asset. The processor is further configured to execute the computer-executable instructions to cause the apparatus to identify the user based on the indication associated with the asset conversion failure incident. The processor is further configured to execute the computer-executable instructions to cause the apparatus to generate an incident report corresponding to the asset conversion failure incident. The processor is further configured to execute the computer-executable instructions to cause the apparatus to transmit the incident report to a user mobile device associated with the user. The incident report may include an asset recovery mechanism associated with an asset recovery operation. The processor is further configured to execute the computer-executable instructions to cause the apparatus to receive an indication of a user interaction with the asset recovery mechanism. The processor is further configured to execute the computer-executable instructions to cause the apparatus to perform the asset recovery operation responsive to receiving the indication of the user interaction with the asset recovery mechanism.

Some implementations described herein relate to an apparatus for asset recovery in association with a self-service retail market environment. The apparatus includes a memory and a processor coupled with the memory. The memory includes computer-executable instructions, and the processor is configured to execute the computer-executable instructions to cause the apparatus to receive an indication associated with an asset conversion failure incident. The asset conversion failure incident may include a failure of a user of the self-service retail market environment to complete a transaction for a retrieved inventory asset. The processor is further configured to execute the computer-executable instructions to cause the apparatus to generate an incident report corresponding to the asset conversion failure incident. The processor is further configured to execute the computer-executable instructions to cause the apparatus to transmit the incident report.

Some implementations described herein relate to an apparatus for asset recovery in association with a self-service retail market environment. The apparatus includes a memory and a processor coupled with the memory. The memory includes computer-executable instructions, and the processor is configured to execute the computer-executable instructions to cause the apparatus to receive an indication associated with an asset conversion failure incident. The asset conversion failure incident may include a failure of a user of the self-service retail market environment to complete a transaction for a retrieved inventory asset. The processor is further configured to execute the computer-executable instructions to cause the apparatus to identify the user based on the indication associated with the asset conversion failure incident. The processor is further configured to execute the computer-executable instructions to cause the apparatus to generate an incident report corresponding to the asset conversion failure incident. The processor is further configured to execute the computer-executable instructions to cause the apparatus to transmit the incident report to a user mobile device associated with the user.

Some implementations described herein relate to a method for asset recovery in association with a self-service retail market environment performable by a computing device. The method includes receiving an indication associated with an asset conversion failure incident. The asset conversion failure incident may include a failure of a user of the self-service retail market environment to complete a transaction for a retrieved inventory asset. The method further includes identifying the user based on the indication associated with the asset conversion failure incident. The method further includes generating an incident report corresponding to the asset conversion failure incident. The method further includes transmitting the incident report to a user mobile device associated with the user. The incident report may include an asset recovery mechanism associated with an asset recovery operation. The method further includes receiving an indication of a user interaction with the asset recovery mechanism. The method further includes performing the asset recovery operation responsive to receiving the indication of the user interaction with the asset recovery mechanism.

Some implementations described herein relate to a method for asset recovery in association with a self-service retail market environment performable by a computing device. The method includes receiving an indication associated with an asset conversion failure incident. The asset conversion failure incident may include a failure of a user of the self-service retail market environment to complete a transaction for a retrieved inventory asset. The method further includes generating an incident report corresponding to the asset conversion failure incident. The method further includes transmitting the incident report.

Some implementations described herein relate to a method for asset recovery in association with a self-service retail market environment performable by a computing device. The method includes receiving an indication associated with an asset conversion failure incident. The asset conversion failure incident may include a failure of a user of the self-service retail market environment to complete a transaction for a retrieved inventory asset. The method further includes identifying the user based on the indication associated with the asset conversion failure incident. The method further includes generating an incident report corresponding to the asset conversion failure incident. The method further includes transmitting the incident report to a user mobile device associated with the user.

Some aspects described herein relate to a non-transitory computer-readable medium that stores a set of instructions for asset recovery in association with a self-service retail market environment. The set of instructions, when executed by one or more processors of a computing device, may cause the computing device to receive an indication associated with an asset conversion failure incident. The asset conversion failure incident may include a failure of a user of the self-service retail market environment to complete a transaction for a retrieved inventory asset. The set of instructions, when executed by the one or more processors of the computing device, may further cause the computing device to identify the user based on the indication associated with the asset conversion failure incident. The set of instructions, when executed by the one or more processors of the computing device, may further cause the computing device to generate an incident report corresponding to the asset conversion failure incident. The set of instructions, when executed by the one or more processors of the computing device, may further cause the computing device to transmit the incident report to a user mobile device associated with the user. The incident report may include an asset recovery mechanism associated with an asset recovery operation. The set of instructions, when executed by the one or more processors of the computing device, may further cause the computing device to receive an indication of a user interaction with the asset recovery mechanism. The set of instructions, when executed by the one or more processors of the computing device, may further cause the computing device to perform the asset recovery operation responsive to receiving the indication of the user interaction with the asset recovery mechanism.

Some aspects described herein relate to a non-transitory computer-readable medium that stores a set of instructions for asset recovery in association with a self-service retail market environment. The set of instructions, when executed by one or more processors of a computing device, may cause the computing device to receive an indication associated with an asset conversion failure incident. The asset conversion failure incident may include a failure of a user of the self-service retail market environment to complete a transaction for a retrieved inventory asset. The set of instructions, when executed by the one or more processors of the computing device, may further cause the computing device to generate an incident report corresponding to the asset conversion failure incident. The set of instructions, when executed by the one or more processors of the computing device, may further cause the computing device to transmit the incident report.

Some aspects described herein relate to a non-transitory computer-readable medium that stores a set of instructions for asset recovery in association with a self-service retail market environment. The set of instructions, when executed by one or more processors of a computing device, may cause the computing device to receive an indication associated with an asset conversion failure incident. The asset conversion failure incident may include a failure of a user of the self-service retail market environment to complete a transaction for a retrieved inventory asset. The set of instructions, when executed by the one or more processors of the computing device, may further cause the computing device to identify the user based on the indication associated with the asset conversion failure incident. The set of instructions, when executed by the one or more processors of the computing device, may further cause the computing device to generate an incident report corresponding to the asset conversion failure incident. The set of instructions, when executed by the one or more processors of the computing device, may further cause the computing device to transmit the incident report to a user mobile device associated with the user.

Some aspects described herein relate to an apparatus for asset recovery in association with a self-service retail market environment. The apparatus may include means for receiving an indication associated with an asset conversion failure incident. The asset conversion failure incident may include a failure of a user of the self-service retail market environment to complete a transaction for a retrieved inventory asset. The apparatus may further include means for identifying the user based on the indication associated with the asset conversion failure incident. The apparatus may further include means for generating an incident report corresponding to the asset conversion failure incident. The apparatus may further include means for transmitting the incident report to a user mobile device associated with the user. The incident report may include an asset recovery mechanism associated with an asset recovery operation. The apparatus may further include means for receiving an indication of a user interaction with the asset recovery mechanism. The apparatus may further include means for performing the asset recovery operation responsive to receiving the indication of the user interaction with the asset recovery mechanism.

Some aspects described herein relate to an apparatus for asset recovery in association with a self-service retail market environment. The apparatus may include means for receiving an indication associated with an asset conversion failure incident. The asset conversion failure incident may include a failure of a user of the self-service retail market environment to complete a transaction for a retrieved inventory asset. The apparatus may further include means for generating an incident report corresponding to the asset conversion failure incident. The apparatus may further include means for transmitting the incident report.

Some aspects described herein relate to an apparatus for asset recovery in association with a self-service retail market environment. The apparatus may include means for receiving an indication associated with an asset conversion failure incident. The asset conversion failure incident may include a failure of a user of the self-service retail market environment to complete a transaction for a retrieved inventory asset. The apparatus may further include means for identifying the user based on the indication associated with the asset conversion failure incident. The apparatus may further include means for generating an incident report corresponding to the asset conversion failure incident. The apparatus may further include means for transmitting the incident report to a user mobile device associated with the user.

Implementations generally include a method, apparatus, system, computer program product, non-transitory computer-readable medium, computing device, network node, network entity, or processing system as substantially described with reference to and as illustrated by the drawings and specification.

The foregoing has outlined rather broadly the features of implementations in accordance with the disclosure in order that the detailed description that follows may be better understood. Additional features will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, will be better understood from the following description when considered in connection with the accompanying figures. Each of the figures is provided for the purposes of illustration and description, and not as a definition of the limits of the claims.

### BRIEF DESCRIPTION OF THE DRAWINGS

This disclosure is best understood from the following detailed description when read in conjunction with the accompanying drawings, which illustrate some aspects of the disclosure, but are not limiting of the scope of the disclosure because the description may enable other aspects in addition to, or in lieu of, those depicted in the drawings. Each of the drawings is provided for purposes of illustration and clarity of description, and not as a definition of the scope of any of the claims. It is emphasized that, according to common practice, the various features of the drawings are not to-scale. On the contrary, the dimensions of the various features are arbitrarily expanded or reduced for clarity.

FIG. 1 is a block diagram of an example of a self-service retail market environment in accordance with the present disclosure.

FIG. 2 is a block diagram of an example of an internal configuration of a computing device of an asset recovery system in accordance with the present disclosure.

FIG. 3 is a block diagram illustrating operations of an example of an asset recovery system in accordance with the present disclosure.

FIG. 4 is a block diagram illustrating notification operations of another example of an asset recovery system in accordance with the present disclosure.

FIG. 5 is a diagram illustrating an example of a graphical user interface (GUI) associated with an asset recovery system in accordance with the present disclosure.

FIG. 6A is a diagram illustrating an example of a GUI associated with an asset recovery system in accordance with the present disclosure.

FIG. 6B is a diagram illustrating another example of a GUI associated with an asset recovery system in accordance with the present disclosure.

FIG. 7A is a diagram illustrating an example of a self-service retail market system in accordance with the present disclosure.

FIG. 7B is another diagram illustrating the example of the self-service retail market system of FIG. 7A.

FIG. 8 is a flowchart illustrating an example of a technique for asset recovery in association with a self-service retail market environment in accordance with the present disclosure.

FIG. 9 is a flowchart illustrating another example of a technique for asset recovery in association with a self-service retail market environment in accordance with the present disclosure.

FIG. 10 is a flowchart illustrating another example of a technique for asset recovery in association with a self-service retail market environment in accordance with the present disclosure.

### DETAILED DESCRIPTION

In a self-service market environment, a user (e.g., a consumer) of the self-service market environment may interact with an asset transaction control device to perform a transaction in which an inventory asset (e.g. a consumable good, such as a food or beverage item, or a non-consumable good, such as headphones or a magazine) is converted into a monetary asset. For example, the transaction may include a retail transaction in which the user provides a payment in exchange for a product. A transaction may be facilitated using input obtained from the user directly at an asset transaction control device or at a user device, such as a mobile device, of the user requesting the transaction. In some examples, application software running on the user device may establish wireless communication with application software running on the asset transaction control device. The established wireless communication may then be used for the transaction. For example, the wireless communication between the user device and the asset transaction control device may be used to provide user input indicative of selectable products and payment information usable to complete a self-service market transaction.

In some cases, a user may fail to complete a transaction to convert an inventory asset into a monetary asset. In some cases, for example, a user might steal an inventory asset, resulting in an asset conversion failure incident. In some other cases, the user might inadvertently fail to complete the transaction (e.g., by forgetting to identify the product for purchase after taking it from a merchandise shelf or cabinet), resulting in an asset conversion failure incident. Whether intentional or unintentional, if the user leaves the vicinity of the self-service retail market with the inventory asset without completing the transaction, the operator of the self-service retail market loses the asset, and thus the value of the asset, due to the asset conversion failure incident. Given the basic nature of self-service markets in avoiding having regular human supervision, an automated software approach is required to facilitate the detection of asset conversion failure incidents.

Various implementations of the present disclosure relate generally to self-service market environments. Some implementations more specifically relate to asset recovery systems for facilitating conversion of inventory assets to monetary assets. For example, an apparatus associated with a self-service retail market environment may receive an indication associated with an asset conversion failure incident. The asset conversion failure incident is a failure of a user of the self-service retail market environment to complete a transaction for a retrieved inventory asset. The indication may indicate the occurrence of an asset conversion failure incident, as well as information associated with the asset conversion failure incident. The apparatus may be, include, or be included in, a server device, and may receive the indication from an asset transaction control device and/or a sensing device, among other examples.

The apparatus may identify the user based on the indication and may generate an incident report corresponding to the asset conversion failure incident. The apparatus may transmit the incident report. For example, in some aspects, the apparatus may transmit the incident report to a user device (e.g., a mobile device or other computing device) associated with the user. The incident report may include a selectable representation associated with an asset recovery operation. The selectable representation may include, for example, a GUI object such as a link, a widget, a button, and/or a toggle, among other examples. The user may select the selectable representation, causing the apparatus and/or another computing device to facilitate performing an asset recovery operation. The asset recovery operation may include a transaction to convert the inventory asset to a monetary asset, an initiation of an offline recovery process against the user, and/or an addition of the user to a list of users associated with asset conversion failure incidents, among other examples.

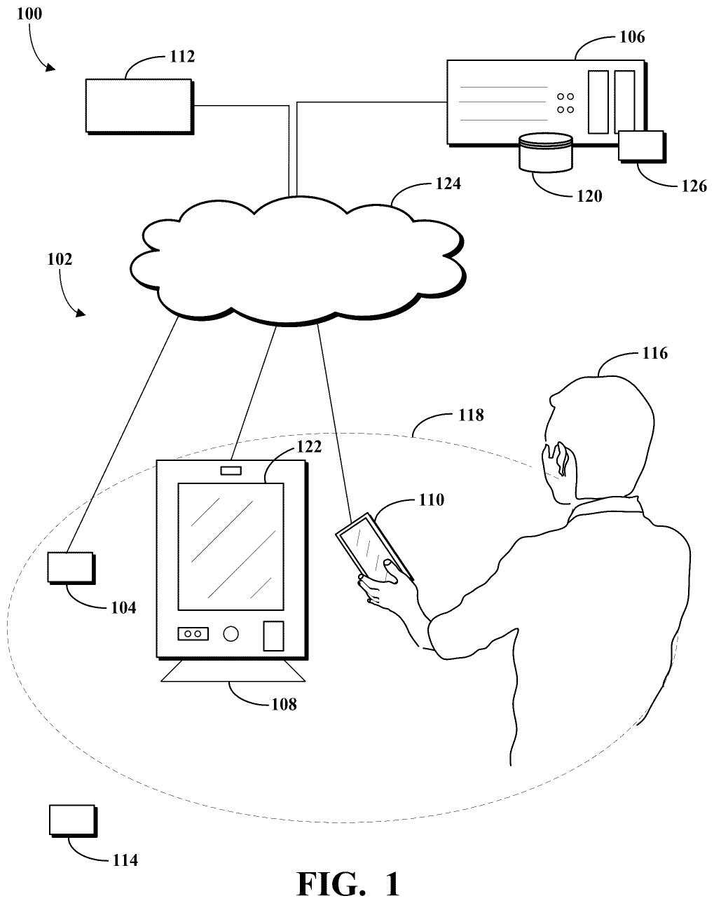

FIG. 1 is a block diagram of an example of a self-service retail market environment 100 in accordance with the present disclosure. The self-service retail market environment 100 may include a system 102 for asset recovery (referred to herein as an “asset recovery system”). The system 102 may include a sensing device 104, a server device 106, an asset transaction control device 108, a user device 110, and/or an operator device 112.

The sensing device 104 is a device that may be used to obtain sensing data associated with one or more inventory assets 114, one or more users 116 (e.g., associated with one or more user devices 110), one or more user devices 110, and/or one or more asset conversion failure incidents. The sensing device 104 may include one or more sensors such as a laser-based time of flight sensor, an ultrasonic-based time of flight sensor, a radio detection and ranging (radar) sensor, a light detection and ranging (LiDAR) sensor, an optical proximity sensor, an inductive proximity sensor, an imaging device (e.g., a camera or a video camera), a pressure sensor and/or a thermal sensor, among other examples. A sensor of the sensing device 104 may detect information and/or actions associated with transactions processed using the asset transaction control device 300. For example, the sensing device 104 may include a camera for capturing images and/or video of a physical area in which the asset transaction control device 108 is located. In another example, the camera may be used to capture images and/or video of user interactions with other components within that physical area. In some examples, the sensing device 104 may detect whether an inventory asset 114 has been removed from an inventory stocking location. In some examples, the sensing device may detect information associated with the user 116.

In some examples, the sensing device 104 may detect the proximity of another device, such as a user device 110, to the asset transaction control device 108 and/or to the sensing device 104. A sensor of the sensing device 104 may include a wireless network component, which may, for example, use Bluetooth®, Bluetooth® Low Energy (BLE), radio frequency identification (RFID), or other wireless connection functionality. For example, the sensing device 104 may detect whether the user device 110 is within a range 118 proximate to the asset transaction control device 108, such as by transmitting a signal within the range 118 and listening for a response to the signal.

In some examples, the sensing device 104 may obtain sensing data and process the sensing data to generate output information. The output information may include sensing measurements and/or indications. For example, the sensing device 104 may generate, based on sensing data, output information indicative of an inventory asset 114. The output information may identify the inventory asset 114 or may be used to determine an identification of the inventory asset 114. In some examples, the sensing device 104 may be integrated with and/or otherwise associated with the asset transaction control device 108 and may be used to determine a proximity of an inventory asset 114 to the asset transaction control device 108.

For example, the sensing device 104 may be used to monitor user access to a secured compartment associated with the asset transaction control device 108. The secured compartment may become unlocked during a transaction processed using the asset transaction control device 108. The sensing device 104 may monitor user interaction with the secured compartment while it is unlocked (and/or before and/or after such unlocking), such as to record that a user action taken with respect to the secured compartment is consistent with a service request associated with the transaction. For example, where the service request is for an inventory asset 114 stored within the secured compartment, the transaction can include unlocking the secured compartment to allow a user to retrieve that consumable product therefrom. The sensing device 104 may thus monitor the user as he or she retrieves the inventory asset 114, such as to determine whether a different inventory asset was instead taken, whether multiple inventory assets were taken, or whether the user did not take the inventory asset at all.

In some examples, the sensing device 104 can be used to record information about the user interacting with the asset transaction control device 108. For example, a camera included in the sensing device 104 can be used to capture an image and/or a video during a transaction processed using the asset transaction control device 108. The image and/or video may be uploaded to a database for further processing, such as to verify that the user is in fact the holder of the account used to complete the transaction with the asset transaction control device 108. For example, the sensing device 104 may be used for facial recognition purposes, such as to authenticate the user of the asset transaction control device 108 prior to completing a transaction requested by that user.

In some examples, the sensing device 104 may generate, based on sensing data, output information indicative of the identity of the user 116. The output information may identify the user 116 or may be used to determine an identification of the user 116. In some examples, the output information may include an image of the user, a partial fingerprint of the user, and/or other identifying information associated with the user, among other examples. In some implementations, the sensing device 104 may be, include, or be included in a payment card reader associated with the asset transaction control device 108 and the output information may indicate a payment card number, a payment card expiration date, a payment card security code, and/or other information obtainable by reading a magnetic strip and/or an RFID chip in the payment card. In some implementations, the sensing device 104 may be, include, or be included in an access control system associated with the self-service retail market environment.

Other examples of sensing devices 104 may be used. For example, the sensing device 104 may include an accelerometer and/or gyroscope for monitoring a movement of the asset transaction control device 108 and/or an inventory asset 114. For example, an unexpected motion of the asset transaction control device 108 and/or an inventory asset 114 may be detected using the sensing device 104. The sensing device 104 may then provide a notification to the server device 106, the asset transaction control device 108, and/or the operator device 112, such as to alert an administrator or other person as to the detected motion.

In yet another example, the sensing device 104 may include temperature sensors for monitoring an internal operating temperature of the asset transaction control device 108, an internal temperature of a secured compartment, or both. For example, the sensing device 104 may detect that the asset transaction control device 108 is overheating or that a secured compartment is not at a low enough temperature (e.g., where the secured compartment is a locked refrigerator or a locked freezer). The sensing device 104 may then transmit a notification to the server device 106, the asset transaction control device 108, and/or the operator device 112, such as to alert an administrator or other person as to the detected temperature.

The sensing device 104 may be plugged into and draw power from the asset transaction control device 108. Alternatively, the sensing device 104 may be plugged into and draw power from a source nearby to the asset transaction control device 108 (e.g., an outlet or another computing device) or utilize battery power. The sensing device 104 may be, include, or be included in, a computing device.

The server device 106 is a computing device that hosts server-side application software and stores information used by the server-side application software and related application software (e.g., client-side application software running on the user device 110). The server device 106 may include an application server and/or a database server. The server device 106 may be a server located in a rack, such as of a data center. Alternatively, the server device 106 may represent a server within a same location as the asset transaction control device 108. In some implementations, the server device 106 includes and/or otherwise communicates with an information repository 120. The information repository 120 is a database software layer that communicates with a database and/or other data store in connection with the processing of a request, such as a request received from the user device 110. For example, the database and/or other data store may be stored remotely at the asset transaction control device 108. In another example, the database or other data store may be stored locally at the server device 106. The information repository 120 uses input parameters received from the asset transaction control device 108, the user device 110, and/or the operator device 112 to query the database or other data store.

The asset transaction control device 108 is a computing device. In some implementations, the asset transaction control device 108 may be located proximate to the sensing device 104. The asset transaction control device 108 may be a kiosk device running point of sales software. For example, a user may retrieve an inventory asset 114 and scan a bar code or similar marking affixed to the inventory asset using the asset transaction control device 108, initiating a transaction for the retrieved inventory asset 114. In some implementations, the asset transaction control device 108 may present a GUI on a display 122. In some implementations, the GUI may facilitate performance of the asset conversion transaction. In some implementations, the asset transaction control device 108 may communicate with the user device 108 to facilitate performance of transaction for the retrieved inventory asset 114.

For example, the asset transaction control device 108 may facilitate transactions in connection with a user account of a market system. The asset transaction control device 108 may include point-of-sales functionality, such as to identify a product for a subject transaction (e.g., using an information look-up, scanning, or other mechanism), determine inventory information for the product, and/or verify user account information necessary for completing the subject transaction (e.g., based on a funding amount of the user account), among other examples.

The asset transaction control device 108 communicates with the server device 106 over a network 124. The network 124 may, for example, be a local area network, a wide area network, a machine-to-machine network, a virtual private network, or another public or private network. The network 124 may include a wired network and/or a wireless network. In some implementations, application software running on the asset transaction control device 108 may be configured, deployed, or otherwise run on the asset transaction control device 108 based on instructions, commands, or other data received from the server device 106 over the network 124.

The user device 110 is a computing device separate from the asset transaction control device 108 and is associated with a user 116. For example, the user device 110 may be a mobile device, such as a smart phone, tablet, laptop, and/or a wearable device, among other examples. In other examples, the user device 110 may be a stationary device, such as a desktop computer and/or a workstation, among other examples. In some cases, the user device 110 can receive, directly or indirectly (e.g., via one or more intermediary devices), a signal from and transmit, directly or indirectly (e.g., via one or more intermediary devices), a response to the sensing device 104 and/or the asset transaction control device 108. The user device 110 may run application software (e.g., client-side application software) used to communicate with the asset transaction control device 108.

In some examples, the user device 110 may be a smartphone running a mobile application or a web application (e.g., via a web browser) at which information associated with a user account registered for purchasing inventory assets can be viewed. The user device 110 may receive alerts related to inventory assets retrieved by the user 116 from the self-service market environment 100, products replaced by the user 116 within the self-service market environment 100, and transactions processed in connection with inventory assets retrieved by the user 116 from the self-service market environment 100. In some cases, the mobile application or web application at the user device 110 may be used to facilitate or otherwise complete a transaction for an inventory asset retrieved from the self-service market environment 100, for example, based on information associated with the inventory asset communicated from the asset transaction control device 108 or identified by a scanning of the product (e.g., a barcode thereof) at a camera of the user device 110, or the like. The user device 110 may display information associated with an account of the user before and/or after such a transaction is processed.

The operator device 112 is a computing device that may be used by an operator of the asset transaction control device 108 and/or the self-service market environment 100 to interface with one or more of the other components of the self-service market environment 100. For example, the operator device 112 may be a laptop, a personal computer, a workstation, and/or a mobile device, among other examples. The operator device 112 may be configured to facilitate interactions between an operator and the sensing device 104, the server device 106, the asset transaction control device 108, and/or the user device 110. In some implementations, for example, an operator may use the operator device 112 to facilitate obtaining information associated with the asset recovery system 102. In some implementations, an operator may use the operator device 112 to facilitate establishing settings, configurations, communications, workflows, and/or parameters associated with the asset recovery system 102.

In some implementations, an asset event manager 126 may be hosted by the server device 106 and may be configured to facilitate asset recovery techniques. The asset event manager 126 may include hardware, software, or a combination of hardware and software. The asset event manager 126 can be distributed across more than one device (e.g., more than one server device 106). In some implementations, the asset event manager 126 may be hosted on a different device in addition to, or in lieu of, a server device 106. For example, in some implementations, the asset event manager 126 may be hosted by the asset transaction control device 108, the sensing device 104, and/or the operator device 112, among other examples. The asset event manager 126 may be, include, or be included in, an apparatus for asset recovery in association with a self-service retail market environment.

In some implementations, the asset event manager 126 may include a processing system that includes one or more memories and one or more processors coupled with the one or more memories. The processing system may be configured to cause the apparatus and/or the asset event manager 126 to receive an indication associated with an asset conversion failure incident, the asset conversion failure incident comprising a failure of a user to complete a transaction to convert an inventory asset into a monetary asset; generate an incident report corresponding to the asset conversion failure incident; and transmit the incident report.

In some implementations, the processing system may be configured to cause the apparatus and/or the asset event manager 126 to receive an indication associated with an asset conversion failure incident, the asset conversion failure incident comprising a failure of a user to complete a transaction to convert an inventory asset into a monetary asset; identify the user based on the indication associated with the asset conversion failure incident; generate an incident report corresponding to the asset conversion failure incident; and transmit the incident report to a user mobile device associated with the user.

In some implementations, the processing system may be configured to cause the apparatus and/or the asset event manager 126 to receive an indication associated with an asset conversion failure incident, the asset conversion failure incident comprising a failure of a user to complete a transaction to convert an inventory asset into a monetary asset; identify the user based on the indication associated with the asset conversion failure incident; generate an incident report corresponding to the asset conversion failure incident; transmit the incident report to a user mobile device associated with the user, the incident report comprising a selectable representation associated with an asset recovery operation; receive an indication of a user selection of the selectable representation; and perform the asset recovery operation responsive to receiving the indication of the user selection of the selectable representation.

In some implementations, there may be multiple asset transaction control devices within a particular physical area. For example, there may be a number of asset transaction control devices that each facilitate transactions for different inventory assets or with respect to different secured compartments. In such an implementation, there may be one sensing device for each asset transaction control device. Alternatively, there may be one or more sensing devices shared by some or all of the multiple asset transaction control devices.

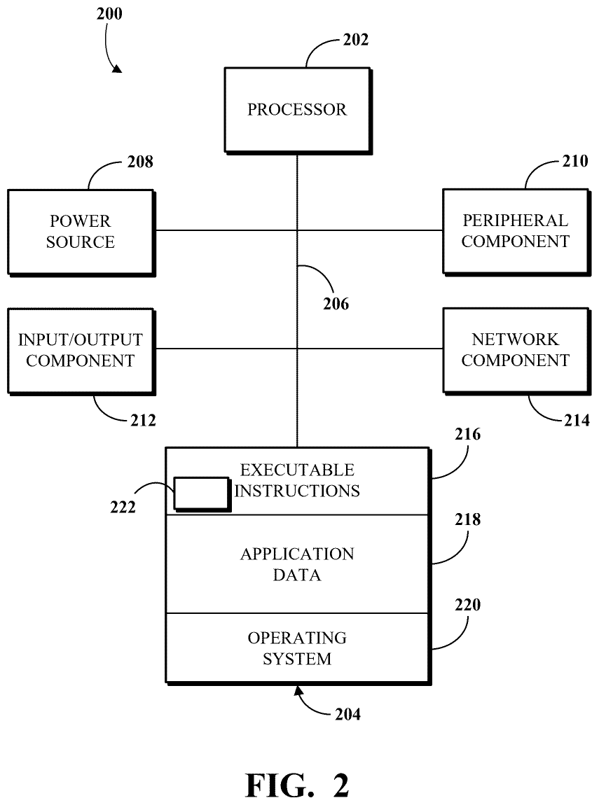

FIG. 2 is a block diagram of an example of an internal configuration of a computing device 200 of an asset recovery system, such as the system 102 depicted in FIG. 1, in accordance with the present disclosure. In some implementations, the computing device 200 may be, be similar to, include, or be included in, an apparatus configured to perform one or more aspects of one or more processes described herein. For example, the computing device 200 may be, be similar to, include, or be included in, the sensing device 104, the server device 106, the asset transaction control device 108, the user device 110, and/or the operator device 112, depicted in FIG. 1. The computing device 200 includes components such as a processor 202, a memory 204, a bus 206, a power source 208, a peripheral component 210, an input/output component 212, and a network component 214. One of more of the memory 204, the power source 208, the peripheral component 210, the input/output component 212, or the network component 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid-state drive, flash memory, phase-change memory, or another form of non-volatile memory configured for persistent electronic information storage. The memory 204 may also include other types of devices, now existing or hereafter developed, configured for storing data or instructions for processing by the processor 202.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. The operating system 220 can be, for example, Microsoft Windows®, Mac OS X®, or Linux®; an operating system for a small device, such as a smartphone or tablet device; or an operating system for a large device, such as a mainframe computer. In some implementations, although illustrated as separate components, the application data 218 and the operating system 220 may be included in and/or be instantiated based at least in part on execution of one or more executable instructions of the executable instructions 216.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system.

The peripheral component 210 includes one or more peripherals (e.g., devices external to the computing device 200 (referred sometimes as “external devices”) and/or one or more peripheral interfaces used to interface the one or more peripherals with the computing device 200 and/or one or more components thereof. The one or more peripherals may include sensors, detectors, or other devices configured for monitoring the computing device 200 and/or the environment around the computing device 200. For example, the peripherals may include a geolocation component, such as a global positioning system location unit. In an example, the peripherals may include a temperature sensor for measuring temperatures of components of the computing device 200, such as the processor 202. In an example, the peripherals may include an imaging device for obtaining optical information of the computing device 200 and/or the environment around the computing device 200. In some examples, peripherals may include a barcode scanner, a funds dispenser, a biometric sensor, and/or a card reader, among other examples. Peripheral interfaces may include software (e.g., drivers and/or virtual ports) used to interface hardware components of the computing device 200 with external devices. Peripheral interfaces may also or instead include hardware (e.g., physical ports and/or related circuitry) used to interface with the external devices.

The input/output component 212 includes one or more input interfaces and/or output interfaces. An input interface may include an input device configured to receive input from a user (e.g., via an interaction between the user and the input device) and/or a machine (e.g., via an interaction between the machine and the input device). An input device may include a mouse, a touchscreen, a keyboard, a microphone, an imaging device, a touchpad, and/or another suitable human or machine interface, among other examples. An output interface may include an output device configured to obtain output information from the processing system and provide a representation (e.g., a visual, audio, and/or tactile representation) of the output information. An output device may, for example, be a display, a light, a speaker, and/or a tactile output device, among other examples.

The network component 214 provides a connection or link to a network such as, for example, a local area network (LAN), a wide area network (WAN), a machine-to-machine network, a virtual private network (VPN), and/or another public or private network. The network component 214 may include a wired network interface and/or a wireless network interface. The computing device 200 can communicate with other devices via the network component 214 using one or more network protocols such as, for example, Ethernet, transmission control protocol (TCP), internet protocol (IP), power line communication, Wi-Fi, Bluetooth®, infrared, general packet radio service (GPRS), global system for mobile communications (GSM), code division multiple access (CDMA), Z-Wave, ZigBee, long term evolution (LTE), and/or New Radio (NR), among other examples.

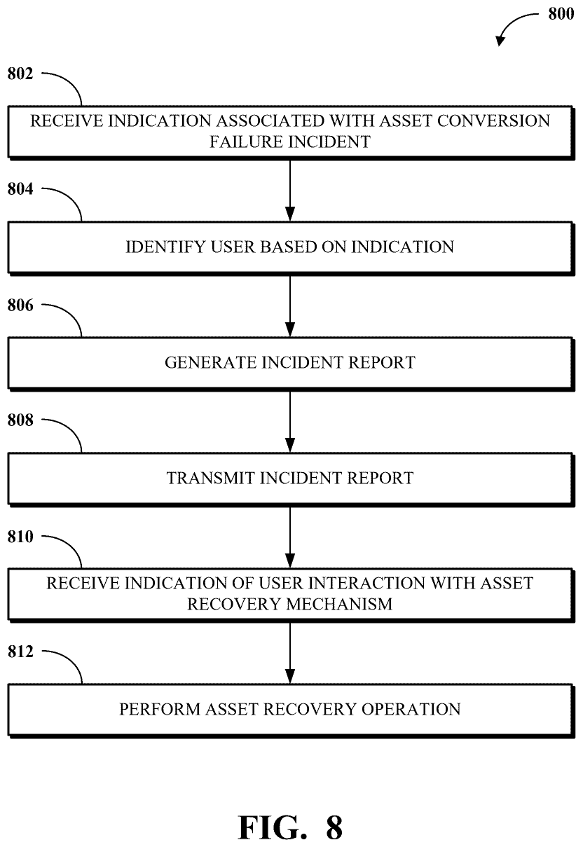

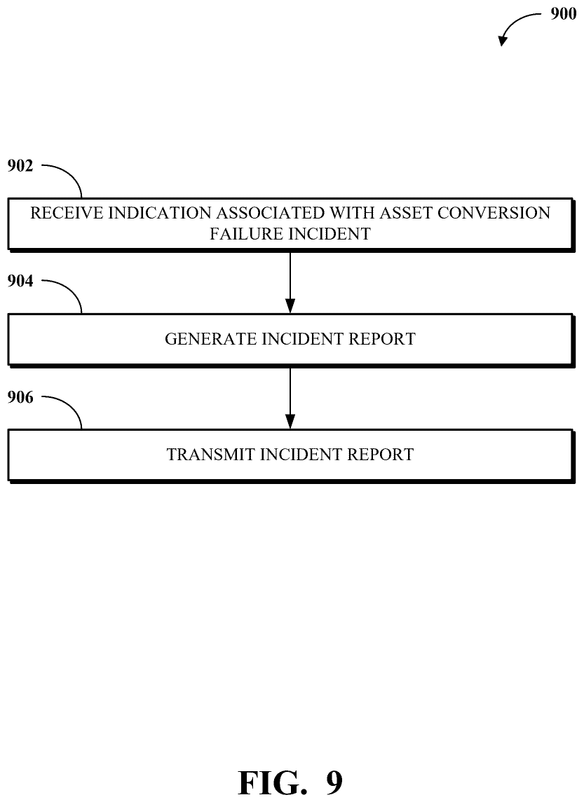

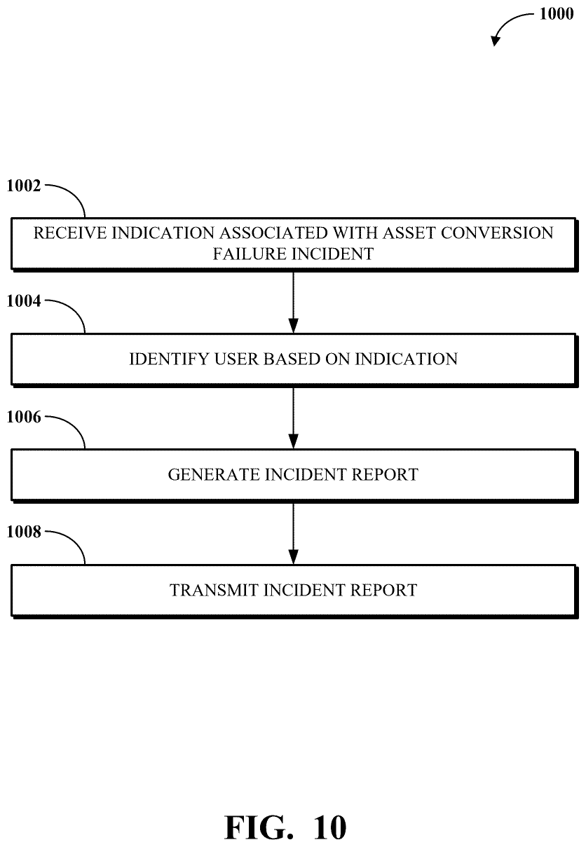

The processor 202 and/or any other component(s) of FIG. 2 may perform one or more techniques associated with asset recovery associated with a self-service retail market, as described in more detail elsewhere herein. For example, the processor 202 and/or any other component(s) of FIG. 2 may perform or direct operations of, for example, the technique 800 of FIG. 8, the technique 900 of FIG. 9, the technique 1000 of FIG. 10, and/or other techniques as described herein. The memory 204 may store data and program codes for the computing device 200. In some examples, the memory 204 may include a non-transitory computer-readable medium storing one or more instructions (e.g., code and/or program code) for wireless communication. For example, the one or more instructions, when executed (e.g., directly, or after compiling, converting, and/or interpreting) by one or more processors 202 of the computing device 200, may cause the one or more processors 202, the computing device 200, and/or an apparatus associated with the computing device 200 to perform or direct operations of, for example, the technique 800 of FIG. 8, the technique 900 of FIG. 9, the technique 1000 of FIG. 10, and/or other techniques as described herein. In some examples, executing instructions may include running the instructions, converting the instructions, compiling the instructions, and/or interpreting the instructions, among other examples. For example, the executable instructions 216 may include a set 222 of instructions that, when executed by the processor 202, are configured to cause the computing device 200 to provide an asset event manager such as, for example, the asset event manager 126 depicted in FIG. 1.

In some aspects, the computing device 200 includes means for receiving an indication associated with an asset conversion failure incident, the asset conversion failure incident comprising a failure of a user to complete a transaction to convert an inventory asset into a monetary asset; means for generating an incident report corresponding to the asset conversion failure incident; and/or means for transmitting the incident report.

In some aspects, the computing device 200 includes means for receiving an indication associated with an asset conversion failure incident, the asset conversion failure incident comprising a failure of a user to complete a transaction to convert an inventory asset into a monetary asset; means for identifying the user based on the indication associated with the asset conversion failure incident; means for generating an incident report corresponding to the asset conversion failure incident; and/or means for transmitting the incident report to a user mobile device associated with the user.

In some aspects, the computing device 200 includes means for receiving an indication associated with an asset conversion failure incident, the asset conversion failure incident comprising a failure of a user to complete a transaction to convert an inventory asset into a monetary asset; means for identifying the user based on the indication associated with the asset conversion failure incident; means for generating an incident report corresponding to the asset conversion failure incident; means for transmitting the incident report to a user mobile device associated with the user, the incident report comprising a selectable representation associated with an asset recovery operation; means for receiving an indication of a user selection of the selectable representation; and/or means for performing the asset recovery operation responsive to receiving the indication of the user selection of the selectable representation.

The means for the computing device 200 to perform operations described herein may include, for example, one or more of the executable instructions 216, processor 202, memory 204, power source 208, peripheral component 210, input/output component 212, and/or network component 214, among other examples.

Any one or more of the components depicted in FIG. 2 may represent one or more of that respective component. For example, the processor 202 may be one or more processors 202, the memory 204 may be one or more memories 204, the power source 208 may be one or more power sources 208, the peripheral component 210 may be one or more peripheral components 210, the input/output component 212 may be one or more input/output components 212, and the network component 214 may be one or more network components 214.

In some implementations, the processor 202, memory 204, and the bus 206 may represent a processing system. A processing system may include one or more processors 202 and one or more memories 204. A processor operation may be an operation described herein as being performed by a processor and/or an operation described herein as being caused, by a processor, to be performed (e.g., an operation that a processor causes an apparatus to perform). In some implementations, a single processor of the one or more processors 202 may perform all of the processor operations described herein as being performed by, or being caused to be performed by, a processor. In some implementations, multiple processors of the one or more processors 202 may perform all of the processor operations described herein as being performed by, or being caused to be performed by, a processor. In some implementations, each processor of multiple processors of the one or more processors 202 may perform a same or different processor operation as another processor of the one or more processors 202. In some implementations, for example, a first set of (one or more) processors of the one or more processors 202 may perform a first processor operation described herein as being performed by, or being caused to be performed by, a processor; and a second set of (one or more) processors of the one or more processors 202 may perform a second operation described herein as being performed by, or being caused to be performed by, a processor. The first set of processors and the second set of processors may be the same set of processors or may be different sets of processors. Reference to “a memory” should be understood to refer to any one or more memories of a corresponding device, such as the one or more memories 204 described in connection with FIG. 2. For example, instructions described as being stored in a memory can be stored in the same subset of the one or more memories 204 or different subsets of the one or more memories 204.

Implementations of the computing device 200 may differ from what is shown and described above with respect to FIG. 2. In some implementations, the computing device 200 can omit the peripherals 210. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

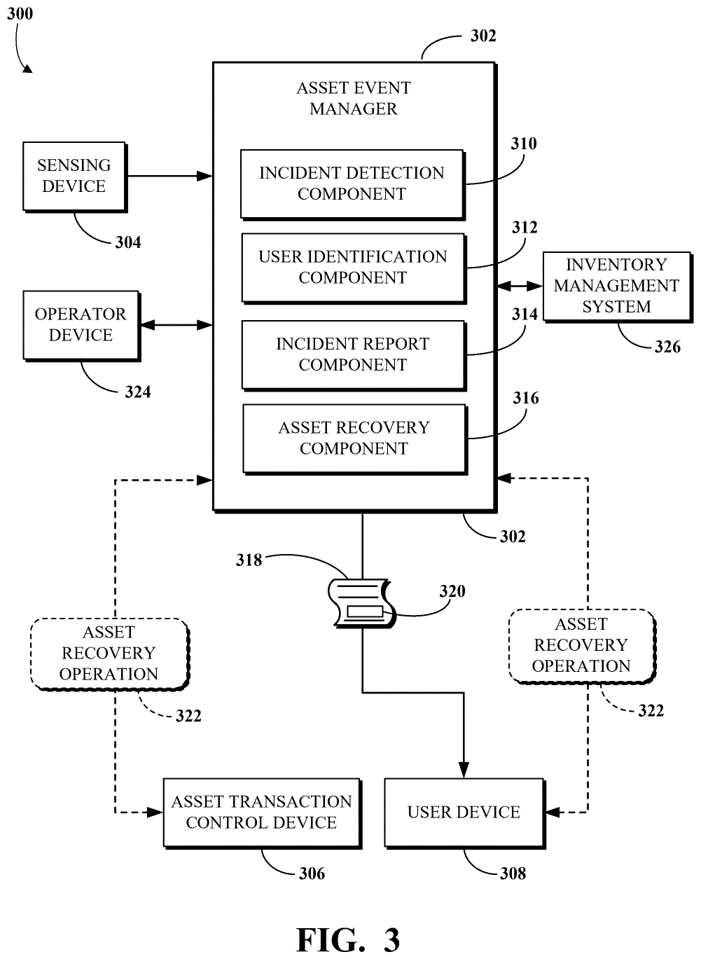

FIG. 3 is a block diagram illustrating operations of an example of an asset recovery system 300 in accordance with the present disclosure. The asset recovery system 300 includes an asset event manager 302, a sensing device 304, an asset transaction control device 306, and a user device 308. The asset event manager 302 may be, be similar to, include, or be included in the asset event manager 126 depicted in FIG. 1. In some implementations, the asset event manager 302 may include software, hardware, and/or a combination thereof. The asset event manager 302 may be run, maintained, and/or instantiated by one or more computing devices such as, for example, the computing device 200 depicted in FIG. 2. The sensing device 304 may be, be similar to, include, or be included in, the computing device 200 depicted in FIG. 2 and/or the sensing device 104 depicted in FIG. 1. The asset transaction control device 306 may be, be similar to, include, or be included in, the computing device 200 depicted in FIG. 2 and/or the asset transaction control device 108 depicted in FIG. 1. The user device 308 may be, be similar to, include, or be included in, the computing device 200 depicted in FIG. 2 and/or the user device 110 depicted in FIG. 1.

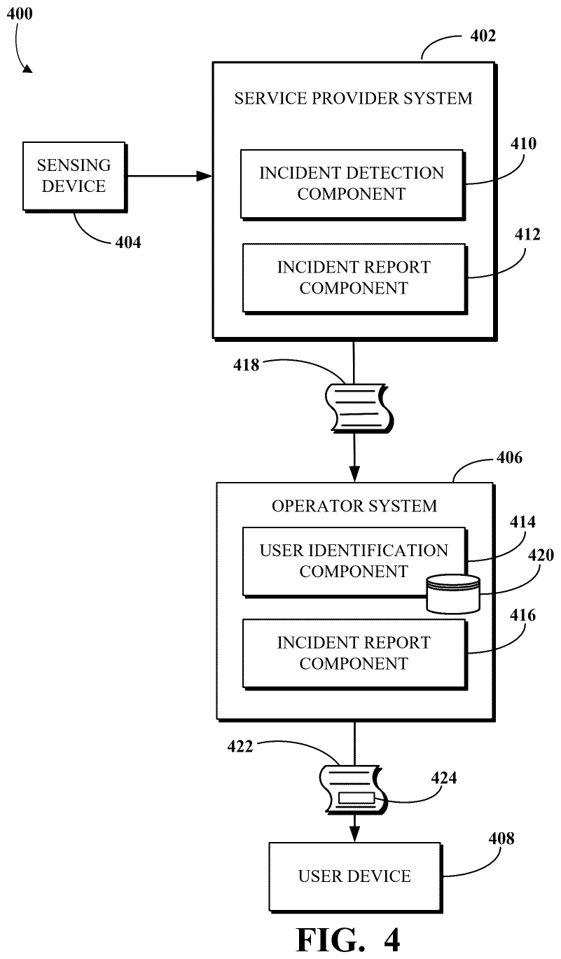

As shown in FIG. 3, the asset event manager 302 may include an incident detection component 310, a user identification component 312, an incident report component 314, and an asset recovery component 316. According to various implementations, two or more of the components 310, 312, 314, and 316 may be integrated with one another. In some implementations, any combination of the components 310, 312, 314, and 316 may be hosted on any combination of computing devices. For example, in some implementations, all of the components 310, 312, 314, and 316 may be hosted on a single computing device or a single system of devices that may be maintained by a single entity. For example, in some implementations, a service provider may maintain the computing device or system and provide asset recovery as a service to an operator of a self-service retail market. In other implementations (as described below, for example, in connection with FIG. 4), the service provider may provide one or more aspects of an asset recovery service to an operator, while the operator (or another service provider) may provide one or more additional aspects of the asset recovery service. For example, in some implementations, one or more of the components 310, 312, 314, and 316 may be hosted by a sensing device (e.g., the sensing device 104 depicted in FIG. 1), a server device (e.g., the server device 106 depicted in FIG. 1), an asset transaction control device 108 (e.g., the asset transaction control device 108 depicted in FIG. 1), and/or a user device (e.g., the user device 110 depicted in FIG. 1), among other examples.

In some implementations, the asset event manager 302 may receive an indication associated with an asset conversion failure incident. The asset event manager 302 may detect (e.g., using the incident detection component 310) the occurrence of the asset conversion failure incident. The asset conversion failure incident may include a failure of a user of the self-service retail market environment to complete a transaction for a retrieved inventory asset. For example, the asset event manager 302 may receive, from the sensing device 304, a communication that includes the indication of the asset conversion failure incident. In an example, the asset event manager 302 may receive, from the asset transaction control device 306, a communication that includes the indication of the asset conversion failure incident. The indication may include any number of different types of information. In an example, the indication may include one or more bits (e.g., one bit, two bits, or more than two bits) that indicate an occurrence of the asset conversion failure incident. In this way, the asset event manager 302 (e.g., using the incident detection component 310) may detect the occurrence of the incident based on the received indication thereof.

In some examples, the indication may be indicative of a potential asset conversion failure incident and the asset event manager 302 may assess evidence provided in the indication to determine whether the potential asset conversion failure incident is actually an asset conversion failure incident. For example, the indication may include sensor data obtain by the sensing device 304 using one or more sensors. The sensor data may be indicative of a potential asset conversion failure incident by including information that may be interpreted to detect an asset conversion failure incident. The asset event manager 302 may interpret the sensor data to determine whether an asset conversion failure incident has occurred (e.g., to determine whether the potential asset conversion failure incident is, in fact, an asset conversion failure incident). For example, the sensor data may include image data indicative of an inventory asset being retrieved by a user of a self-service retail market and being removed from the self-service retail market environment. The asset event manager 302 may interpret the image data as a potential asset conversion failure incident (e.g., by labeling the image data and/or recording one or more values in a memory that associate the image data with a potential asset conversion failure incident identifier). The asset event manager 302 may identify the inventory asset depicted in the image data and may access a data store (e.g., a transaction database and/or inventory management system) to determine whether the identified inventory asset was the subject of a transaction during a time frame and/or at a location corresponding to the image data (e.g., a purchase transaction). If the asset event manager 302 determines that the inventory asset was not the subject of a transaction during a time frame and/or at a location corresponding to the image data, the asset event manager 302 may determine that the image data is indicative of an asset conversion failure incident and may thereby detect an occurrence of the asset conversion failure incident. In implementations, the asset event manager 302 may identify the inventory asset based on at least one of any number of different types of inventory asset identification information such as, for example, image data (e.g., in which a computer vision system may be used to identify the inventory asset), RFID information (e.g., in which an RFID tag associated with the inventory asset may be read by an RFID tag reader associated with the self-service retail market), magnetic identification information, and/or one or more sensors (e.g., capacitive force sensors, light sensors, and/or weight sensors, etc.) associated with a storage and/or display apparatus from which the inventory asset is retrieved, among other examples.

In some implementations, the indication may be indicative of user identification information, inventory asset identification information, and/or transaction information, among other examples. User identification information may be any type of information associated with a user and/or from which an identify of the user may be determined. User identification information may include a name of the user, a payment card number of a payment card associated with the user, a location of the user, an image of the user, a partial image of the user, a user device identifier (ID) of a user device associated with the user, a credential associated with the user (e.g., a username, password, and/or biometric value), and/or an account ID associated with the user, among other examples. Inventory asset identification information may be any type of information associated with an inventory asset and/or from which an identity of the inventory asset may be determined. Inventory asset information may include a name of the inventory asset, a location of the inventory asset, an image of the inventory asset, a partial image of the inventory asset, and/or an inventory asset ID (e.g., a barcode and/or other ID) of the inventory asset, among other examples. Transaction information may include any type of information associated with an asset conversion transaction. For example, transaction information may include a transaction ID, a date of the transaction, a time of the transaction, a location of the transaction, a user associated with the transaction, an asset transaction control device associated with the transaction, an identification of a user device associated with the transaction, and/or a status of the transaction (e.g., an indication that the transaction has been initiated, completed, not initiated, and/or not completed), among other examples.

Using one or more of the incident detection component 310, the user identification component 312, the incident report component 314, and the asset recovery component 316, the asset event manager 302 may identify a user associated with the asset conversion failure incident. For example, the asset event manager 302 may identify the user associated with the asset conversion failure incident based on the indication (e.g., by using information included in the indication). In some examples, the asset event manager 302 may identify the user based on user identification information. In some examples, the asset event manager 302 may identify the user based on the user identification information and a user database that includes a user record associated with the user. For example, the asset event manager 302 may query the user database to extract information associated with the user identification information. For example, the asset event manager 302 may provide the user database with a payment card number associated with the asset conversion failure incident and obtain, in response, an indication of an identity of the user, a phone number associated with the user, and/or an email address associated with the user, among other examples.

In some implementations, for example, an asset conversion failure incident may arise as a result of a phenomenon referred to as “under-ringing.” Under-ringing occurs when a user brings a number of inventory assets to a location proximate an asset transaction control device (e.g., the asset transaction control device 306), “rings up” (e.g., by scanning a barcode using a barcode scanner) one or more of the inventory assets but fails to ring up one or more others of the inventory assets. For example, a user may bring three cans of soda to the asset transaction control device 306 and may ring up only two of the three cans, resulting in a transaction in which the user only pays for two of the three cans. In under-ringing cases such as these, the sensing device 304 may detect that three cans were brought within the vicinity (e.g., within a range) of the asset transaction control device 306. For example, the sensing device 304, using one or more sensors such as imaging devices, RFID detectors, and/or magnet detectors, may determine that three cans were brought near (e.g., close enough to the asset transaction control device that one or more of the cans could be scanned to facilitate a transaction associated therewith) the asset transaction control device 306. The asset event manager 302 may determine that only two of the three cans were the subject of a transaction. For example, the asset event manager 302 may receive sensing information from the sensing device 304 indicative of the cans that were scanned by the user and/or the asset event manager 302 may obtain transaction information indicative of the two cans that were scanned at the asset transaction control device 306. The sensing information and/or the transaction information may be indicative of a fact that two of three total retrieved inventory assets were scanned and paid for. In some examples, the sensing information and/or the transaction information may specifically identify each inventory asset of the two assets (or three) and, in other examples, the sensing information and/or the transaction information may identify a type of inventory asset and a quantity associated therewith. For example, the sensing information and/or the transaction information may indicate that three inventory assets of a certain inventory asset type (e.g., a soda) were retrieved by the user of the self-service retail market, and that two inventory assets of the inventory asset type were paid for (e.g., were the subject of a transaction). To illustrate, one non-limiting example may refer to the sensing device 304 using one or more imaging devices (i.e., cameras) in a computer vision system for object recognition, such as to detect a number of inventory assets retrieved by a user, identify those inventory assets based on perceptible visual qualities (e.g., per a training of the computer vision system), and compare the identified inventory assets and the number of thereof against items scanned or otherwise presented by the user for a subject transaction. The asset event manager 302 may thus detect an under-ringing event based on the fact that not all of the retrieved inventory assets were the subject of a transaction (though at least one was). The under-ringing event may be an occurrence of an asset conversion failure incident. In cases in which the user uses a form of payment (e.g., a mobile device-based pay service or a credit card) other than cash or a gift card, the asset transaction control device 306 may receive user information such as, for example, a credit card number and/or a cell phone number, and may provide that user information to the asset event manager 302. The asset event manager 302 may associated the user information with the asset conversion failure incident. This user information may be used by the asset event manager 302 to identify the user for notifying the user of the asset conversion failure incident and/or for performing an asset recovery operation.

In some examples, the user identification information includes an image of the user. The asset event manager 302 may perform a facial recognition operation to identify the user based on the image of the user. The image may be a full image of the user or a partial image of the user. Any number of different types of facial recognition techniques may be used to identify the user based on a partial image or a full image. In some examples, the user identification information may include other biometrics such as, for example, a fingerprint (or partial fingerprint), and/or a retina scan (or partial retina scan), among other examples.

The asset event manager 302 (e.g., using the incident report component 316) may generate an incident report 318 corresponding to the asset conversion failure incident. In various implementations, for example, the asset event manager 302 may generate the incident report 318 in association with receiving the indication associated with the asset conversion failure incident and/or in association with identifying the user associated with the asset conversion failure incident. For example, using the indication associated with the asset conversion failure incident, the asset event manager 302 may determine that the asset conversion failure incident has occurred. The asset event manager 302 may generate the incident report 318 responsive to determining the occurrence of the asset conversion failure incident.

The asset event manager 302 may provide (e.g., transmit) the incident report 318 to the user device 308 and/or to the operator device 324. In some implementations, the asset event manager 302 may provide the incident report 318 to an inventory management system 326. The inventory management system 326 may include any one or more computing devices (e.g., the computing device 200 depicted in FIG. 2) configured to store, track, and/or otherwise manage inventory information associated with one or more self-service retail markets. For example, the inventory management system 326 may be maintained by the operator of the self-service retail market environment and/or an aspect thereof. In some examples, the inventory management system 326 may be maintained by a service provider that manages inventory for the self-service retail market environment. The inventory management system 326 may be, include, and/or be included in, the operator device 324, the asset event manager 302, and/or the asset transaction control device 306.

In some examples, the operator device 324 and/or the inventory management system 326 may be used to view the incident report 318 and/or information associated therewith (e.g., aggregated information associated with a number of incident reports 318). The operator device 324 and/or the inventory management system 326 may be used to facilitate an asset recovery operation 322, to update inventory records based on the asset conversion failure incident, to provide inventory asset identification information associated with a detected asset conversion failure incident, and/or to manage one or more aspects of the asset event manager 302, among other examples. For instance, in response to receiving the incident report 318, the inventory management system 326 may reduce an inventory count associated with the identified inventory asset type by one, thereby updating the inventory count based on the occurrence of the asset conversion failure incident.

The incident report 318 may include any number of different types of information. In some examples, the incident report 318 may include an indication of the asset conversion failure incident. In some examples, the incident report 318 may be indicative of an identification of an inventory asset associated with the asset conversion failure incident, an identification of a user associated with the asset conversion failure incident, a date upon which the asset conversion failure incident occurred, a time at which the asset conversion failure incident occurred, a lost asset value associated with the asset conversion failure incident, a phone number associated with the user, an email address associated with the user, and/or other information associated with the asset conversion failure incident.

In some examples, the incident report 318 may include an asset recovery mechanism 320 for facilitating an asset recovery operation. In some implementations, as shown in FIG. 3, the asset recovery operation 322 may be performed by the asset event manager 302 and the user device 308. In some other implementations, the asset recovery operation 322 may be performed by the asset event manager 302 and the asset transaction control device 306. In some implementations, the asset event manager 302 (or one or more components thereof) may be hosted by the asset transaction control device 306, in which case the asset recovery operation may be performed by the asset transaction control device 306 and/or the user device 308. The asset recovery operation 322 may include facilitating an exchange of value for the inventory asset associated with the asset conversion failure incident. For example, the asset recovery operation 322 may include a transaction in which the user pays for the inventory asset (e.g., via a payment card and/or account).

For example, the asset recovery mechanism 320 may include information or instructions that, when processed by a processor associated with a computing device (e.g., the user device 308) may cause the computing device to present (e.g., output for display) a selectable representation associated with an asset recovery operation. The selectable representation may include a button, a widget, a hyperlink, and/or an icon, among other examples. The user may interact with the asset recovery mechanism 320 such as, for example, by selecting (e.g., clicking or touching) the selectable representation. User interaction with asset recovery mechanism 320 may facilitate initiation of an asset recovery operation 322. For example, in some implementations, user interaction with the asset recovery mechanism 320 may cause the user device 308 to transmit an asset recovery operation request to the asset event manager 302. The asset event manager 302 may transmit a response to the user device 308 and, in some cases, may facilitate (e.g., using the asset recovery component 316) the asset recovery operation 322 to recover the value of the inventory asset associated with the asset conversion failure incident. For example, upon receiving the asset recovery operation request from the user device 308, the asset recovery component 316 may provide a digital interface through which the user may complete a transaction corresponding to the asset recovery operation. For example, the digital interface may include a web page, a transaction portal, a GUI provided by a self-service market application running at the user device, and/or any other type of digital interface configured to facilitate an asset recovery operation. The digital interface may be populated with information associated with the asset conversion failure incident (e.g., inventory asset information identifying the inventory asset, user information identifying the user, user payment information suggesting a method of payment, user account information, and/or location information associated with the self-service retail market, among other examples). In some cases, the asset recovery component 316 may, via the digital interface, provide information associated with a proposed asset recovery operation and a selectable option to approve (e.g., execute) the proposed asset recovery operation. For example, the asset recovery component 316 may provide a GUI indicative of a proposal to debit a user account and/or to charge a user credit card that is on file with the operator of the self-service retail market environment. The GUI may include a selectable button that, when interacted with by the user, may cause the asset recovery component 316 to initiate the proposed asset recovery operation.

In some cases, the asset event manager 302 may perform the asset recovery operation 322 in part by associating an identification of the user with a value indicative of the occurrence of the asset conversion failure incident. For example, in some implementations, the asset event manager 302 may place the user on a “blacklist” associated with the self-service retail market environment. In some examples, removal of the user from the blacklist may be achieved in response to successful completion of an asset recovery operation 322 (e.g., in response to receiving payment for the inventory asset from the user). In some examples, the blacklist may be used to prevent access, by the user, to the self-service retail market and/or one or more other self-service retail markets.

In some examples, the user device 308 may be a mobile device. In such example, the incident report 318 may be transmitted to the user device 308 via a short messaging service (SMS), a push notification associated with a client application installed on the mobile device, and/or any other type of communication receivable by the mobile device. In some examples, the user device 308 may be a laptop, desktop, and/or workstation, among other examples. In such examples, the incident report 318 may be transmitted to the user device 308 via an SMS, an email message, and/or any other type of communication receivable by the user device 308. The user device 308 that receives the incident report 318 may be the same as, or different from, the user device 308 that performs the asset recovery operation 322.

In some implementations, the incident report 318 may indicate a time period within which the asset recovery operation is to be performed. If the user fails to perform the asset recovery operation within the indicated time period, further collection action and/or legal action may be taken. In some examples, the incident report 318 may be indicative of the further collection action and/or legal action that is to be taken responsive to a failure of completion of an asset recovery operation 322 within the indicated time period. For example, in some cases, the asset event manager 302 may start an asset recovery timer upon transmitting the incident report 318 associated with an asset conversion failure incident. Responsive to determining a completion of a corresponding asset recovery operation 322, the asset event manager 302 may terminate the asset recovery timer. Responsive to detecting an expiration of the asset recovery timer, the asset event manager 302 may provide an indication (e.g., to an operator of the self-service market environment) of the expiration of the asset recovery timer. In some examples, the asset event manager 302 may, responsive to detecting an expiration of the asset recovery timer, generate a collection indication and transmit the collection indication to a collection device (e.g., a computing device operated by a collection organization). In some examples, the asset event manager 302 may, responsive to detecting an expiration of the asset recovery timer, generate a legal report indication and transmit the legal report indication to a law enforcement device (e.g., a computing device operated by a law enforcement organization or a service that initiates law enforcement actions). In this manner, some aspects of implementations disclosed herein may automatically initiate collection actions and/or legal actions associated with asset conversion failure incidents.

In some examples, expiration of an asset recovery timer may be delayed in association with a reminder delay timer. For example, the asset event manager 302 may start a reminder delay timer responsive to transmitting the incident report 318. The asset event manager 302 may detect an expiration of the reminder delay timer and may transmit, based on the expiration of the reminder delay timer, a reminder communication to the user device 308 (or other computing device). For example, in some implementations, the asset event manager 302 may transmit the incident report 318 to a first user device 308 and may transmit a reminder to a second user device. Destination devices for transmitting reminders may be determined in association with a reminder threshold. For example, the asset event manager 302 may be configured to transmit a reminder to the second user device 308 only after transmitting a specified number of reminders to the first user device 308. In some implementations, the asset recovery timer expiration may be based on a time period and/or the reminder threshold.

In some implementations, as shown in FIG. 3, an operator device 324 may communicate with the asset event manager 302. In some implementations, for example, one or more components of the asset event manager 302 and/or one or more instances of the asset event manager 302 (or one or more components thereof) may be hosted by the operator device 324. In some implementations, the operator device 324 may interface with the asset event manager 302 such as, for example, via a browser, a portal, and/or a VPN, among other examples. The operator device 324 may facilitate management of the asset event manager 302 by an operator. For example, the operator may use the operator device 324, which may present a GUI, to set values of parameters, settings, and/or other adjustable mechanisms associated with an asset recovery system as described herein. For example, the operator device 324 may be used to establish asset recovery time periods, reminder delay timer values, conditions for detection of asset conversion failure incidents, conditions for identification of users, settings (e.g., content settings, format settings, transmission settings) associated with incident report generation and/or transmission, rules associated with blacklists, rules associated with account permissions and/or roles, and/or parameters associated with asset recovery operations, among other examples. In some example, upon completion of an asset recovery operation, the asset recovery component 316 may provide an indication of the completion of the asset recovery operation to the user device 308, the operator device 324, and/or the inventory management system 326.

As indicated above, FIG. 3 is provided as an example. Implementations of the asset recovery system 300 may differ from what is shown and described with respect to FIG. 3.

FIG. 4 is a block diagram illustrating notification operations of another example of an asset recovery system 400 in accordance with the present disclosure. The asset recovery system 400 may be, be similar to, include, or be included in, the asset recovery system 300 depicted in FIG. 3. The example asset recovery system 400 is a system in which some aspects of the asset recovery process are provided by components of an asset event manager (e.g., the asset event manager 302 depicted in FIG. 3) that have been distributed between two different systems.

For example, as shown, the asset recovery system 400 includes a service provider system 402, a sensing device 404, an operator system 406, and a user device 408. The service provider system 402 may be implemented using any number of computing devices (e.g., the computing device 200 depicted in FIG. 2). The sensing device 404 may be, be similar to, include, or be included in, the computing device 200 depicted in FIG. 2 and/or the sensing device 104 depicted in FIG. 1. The operator system 406 may be, be similar to, include, or be included in, the operator device 324 depicted in FIG. 3, the computing device 200 depicted in FIG. 2, the operator device 112 depicted in FIG. 1, and/or the asset transaction control device 108 depicted in FIG. 1. The user device 408 may be, be similar to, include, or be included in, the computing device 200 depicted in FIG. 2 and/or the user device 110 depicted in FIG. 1. In some implementations, one or more of the incident detection component 410, the incident report component 412, the user identification component 414, and the incident report component 416 may be referred to as an asset event manager (e.g., similar to the asset event manager 302 depicted in FIG. 3).

As shown in FIG. 4, the service provider system 402 may include an incident detection component 410 and an incident report component 412. The operator system 406 may include a user identification component 414 and another incident report component 416. In some implementations, the service provider system 402 may receive an indication associated with an asset conversion failure incident. The service provider system 402 may detect (e.g., using the incident detection component 410) the occurrence of the asset conversion failure incident. The asset conversion failure incident may include a failure of a user to complete a transaction to convert an inventory asset into a monetary asset. For example, the service provider system 402 may receive, from the sensing device 404, a communication that includes the indication of the asset conversion failure incident. The service provider system 402 may generate (e.g., using the incident report component 412) an incident report 418 and transmit that incident report 418 to the operator system 406.

The operator system 406 may identify (e.g., using the user identification component 414) a user associated with the asset conversion failure incident. In some examples, the operator system 406 may identify the user based on the user identification information and a user database that includes a user record associated with the user. For example, the user identification component 414 may query a user database 420 to extract information associated with the user identification information. The operator system 406 may generate (e.g., using the incident report component 416) an additional incident report 422, which the operator system 406 may transmit to the user device 408. The additional incident report 422 may be generated using the incident report 418 (e.g., by appending additional information to the incident report 418 or by simply forwarding the incident report 418 to the user device 408). In some examples, the additional incident report 422 may include an asset recovery mechanism 424 for facilitating an asset recovery operation, as described above in connection with FIG. 3. In some examples, as described above in connection with FIG. 3, the operator system 406 may automatically update inventory records in response to receiving the incident report 418. In some examples, the operator system 406 may be used by a user thereof to view information associated with one or more detected asset conversion failure incidents, to facilitate asset recovery operations, and/or to adjust, adapt, control, and/or otherwise manage, one or more aspects of an asset event manager (e.g., the asset event manager 302 depicted in FIG. 3).

As indicated above, FIG. 4 is provided as an example. Implementations of the asset recovery system 400 may differ from what is shown and described with respect to FIG. 4.

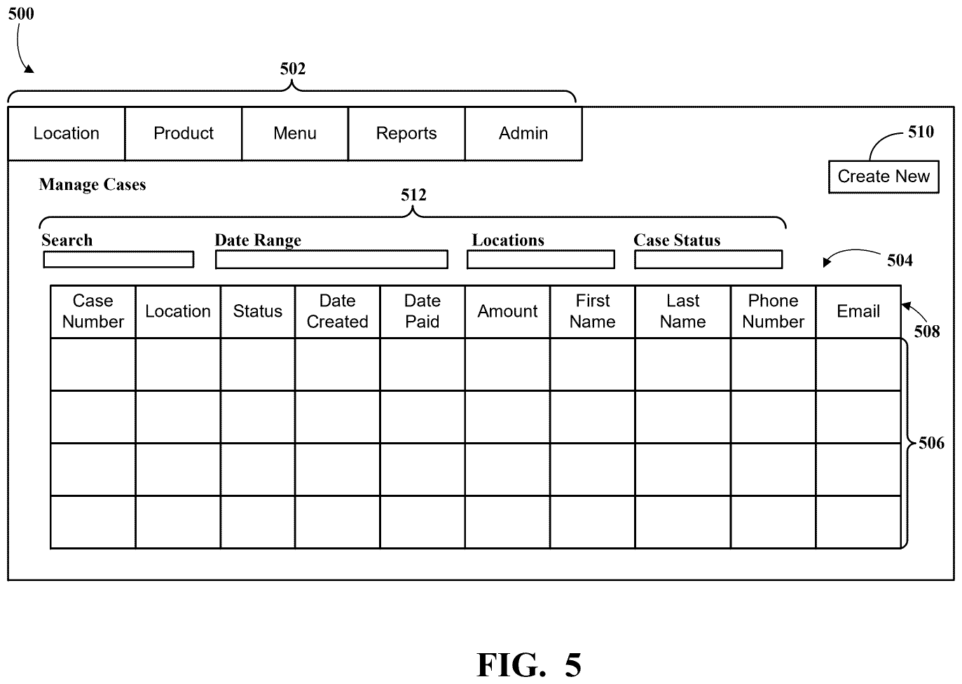

FIG. 5 is a diagram illustrating an example of a GUI 500 associated with an asset recovery system in accordance with the present disclosure. For example, the GUI 500 may be presented on a display device of a computing device (e.g., a computing device of the service provider system 402 depicted in FIG. 4, a computing device of the operator system 406 depicted in FIG. 4, a computing device associated with the asset event manager 302 depicted in FIG. 3, the asset transaction control device 306 depicted in FIG. 3, the operator device 324 depicted in FIG. 3, and/or the computing device 200 depicted in FIG. 2, among other examples). In some implementations, the GUI 500 may facilitate management of asset conversion failure incidents. For example, each asset conversion failure incident that has been detected may be assigned a case number and, thus, referred to as a case or by the case number. A user associated with a service provider of an asset recovery service and/or a user associated with an operator of a self-service retail market may interact with the GUI 500 to facilitate management of various cases associated with asset conversion failure incidents.

As shown, the GUI 500 may include a set 502 of tabs (or other selectable GUI elements such as, for example, buttons and/or drop-down menu elements). A user may select a tab of the set 502 of tabs to access a window, tab, pop-up, or other GUI that may facilitate interaction with a functionality identified on the tab of the set 502 of tabs. For example, the user may select the “Location” tab to access a GUI that provides location-specific functionality, the “Product” tab to access a GUI that provides product-specific functionality, the “Menu” tab to access a GUI that provides a menu of functionalities, the “Reports” tab to access a GUI that provides report-generation functionality, and/or the “Admin” tab to access a GUI that provides administrator functionality. In some examples, any number of different types of tabs may be provided.

As is further shown, the GUI 500 may include a table 504 that provides information associated with asset conversion failure incident cases. For example, each row of a set 506 of rows of the table 504 may correspond to an asset conversion failure incident case. The table 504 may include any number of columns with a header row 508 that identifies the data found in each column. For example, for each of one or more asset conversion failure incident cases included in the table 504, the table may provide a case number, a location (e.g., a location of the corresponding asset conversion failure incident), a status (e.g., paid, unpaid, etc.), a date created, a date paid, an amount, a first name of a user associated with the asset conversion failure incident, a last name of the user associated with the asset conversion failure incident, a phone number associated with the user, and/or an email address associated with the user, among other examples. In some examples, the GUI 500 may include a selectable GUI element 510 that, when selected by the user, may facilitate adding a new asset conversion failure incident case to the table. As is further shown, the GUI 500 may include a set 512 of search input fields that may be used to facilitate filtering results shown in the table 504. In this manner, the asset conversion failure incident cases may be filtered using any number of different attributes such as, for example, a key-word search, a date range, a location, and/or a status, among other examples.

As indicated above, FIG. 5 is provided as an example. Implementations of the GUI 500 may differ from what is shown and described with respect to FIG. 5. For example, any number of different types of layouts and/or types of information may be used to facilitate asset conversion failure incident case management via the GUI 500.

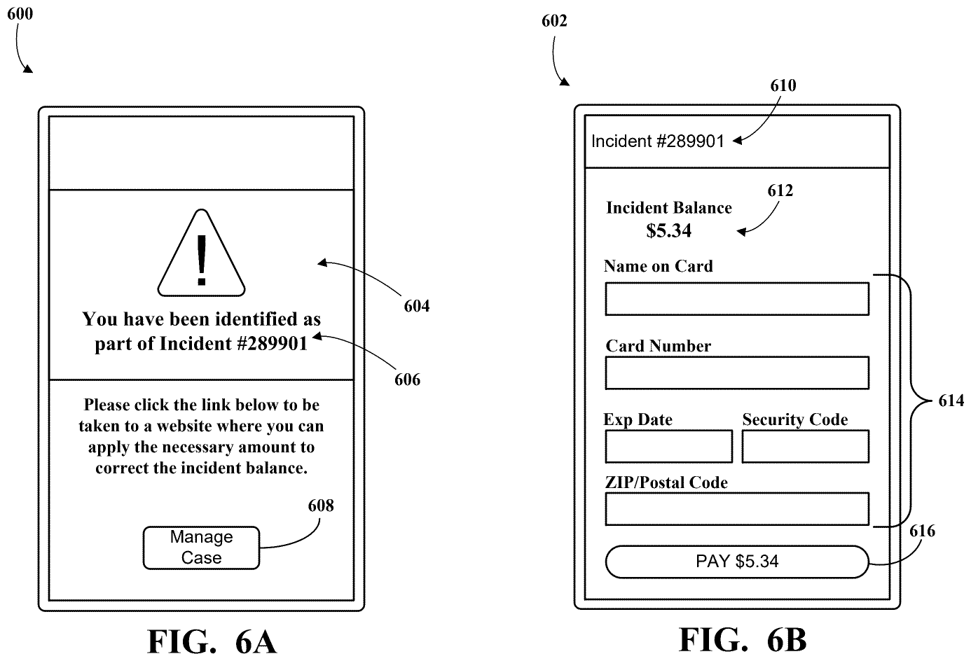

FIGS. 6A and 6B are diagrams illustrating examples of a GUI 600 and a GUI 602, respectively, associated with an asset recovery system in accordance with the present disclosure. For example, the GUI 600 and/or the GUI 602 may be presented on a display device of a computing device (e.g., the asset transaction control device 306 depicted in FIG. 3, the user device 308 depicted in FIG. 3, and/or the computing device 200 depicted in FIG. 2, among other examples).

In some implementations, the GUI 600 may be presented on a user device (e.g., a mobile device) to notify the user of the user device of an asset conversion failure incident associated with the user. As shown, for example, the GUI 600 may include a warning indicator 604 and an indication 606 of an associated asset conversion failure incident case number. The GUI 600 may include an asset recovery mechanism 608 for facilitating an asset recovery operation, as described above with reference to FIGS. 3 and 4. For example, the asset recovery mechanism 608 may include a selectable representation that, upon selection by the user, causes an asset recovery system to initiate an asset recovery operation. For example, upon selecting the asset recovery mechanism 608, the user device may be caused to present the GUI 602. The GUI 602 may be configured to facilitate an asset recovery operation. For example, the GUI 602 may be a GUI that a user can interact with to complete a payment for an item associated with an asset conversion failure incident. As shown, the GUI 602 may include an indication 610 of the asset conversion failure incident case number (which may be referred to herein alternatively as an asset conversion failure incident number) and an indication 612 of an amount associated with the corresponding asset conversion failure incident. The GUI 602 may include a set 614 of input fields for inputting payment information (e.g., credit card information and/or bank account information, among other examples) and a selectable GUI element 616 for executing a transaction to pay for the inventory asset associated with the asset conversion failure incident. In some examples, the GUI 602 may include any number of other types of information and/or selectable GUI elements that may be used to facilitate an asset recovery operation.

As indicated above, FIGS. 6A and 6B are provided as examples. Implementations of the GUIs 600 and 602 may differ from what is shown and described with respect to FIGS. 6A and 6B. For example, any number of different types of layouts and/or types of information may be used to facilitate asset conversion failure operations via the GUI 600 and/or the GUI 602.

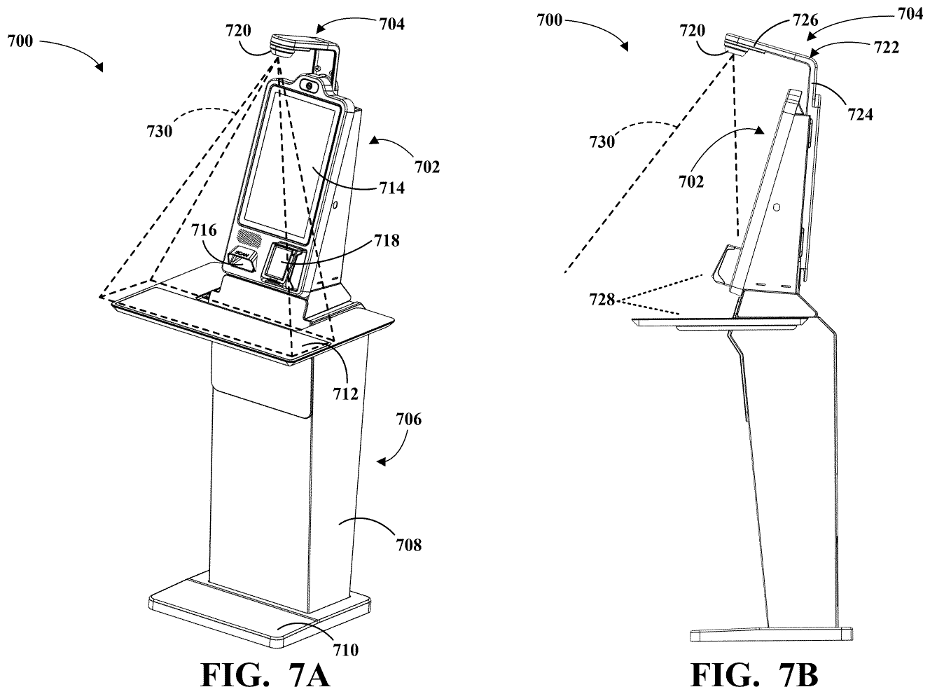

FIGS. 7A and 7B depict an example of a self-service retail market system 700 in accordance with the present disclosure. The self-service retail market system 700 may be deployed in a self-service retail market environment such as, for example, the self-service retail market environment 100 depicted in FIG. 1. In some examples, the self-service retail market system 700 (and/or one or more components thereof) may be, be similar to, include, or be included in, an asset recovery system (e.g., the asset recovery system 102 depicted in FIG. 1). As shown, the self-service retail market system 700 may include an asset transaction control device 702 and a sensing device 704 associated therewith. The asset transaction control device 702 may be configured to facilitate a transaction for a retrieved inventory asset, as described herein. For example, the asset transaction control device 702 may be a kiosk device running point of sales software.

In the illustrated example, the asset transaction control device 702 and the sensing device 704 are positioned on a stand assembly 706. In other examples, the asset transaction control device 702 and the sensing device 704 may be disposed on a shelf, a shelving unit, a display assembly, a counter, or any other structure suitable for housing the asset transaction control device 702 and the sensing device 704. As shown, the stand assembly 706 may include a body 708 extending vertically from a base 710. The body 708 may be formed in any number of different shapes and/or arrangements. In some examples, the body 708 may be one or more independent or connected structures such as columns or legs. In some examples, at least a portion of the body 708 of the stand assembly 706 may include a cavity. The cavity may house one or more electrical wires and/or components and/or one or more computing devices, among other examples. A shelf 712 may be coupled to the body 708. The shelf 712 may be adjacent the asset transaction control device 702. For example, the shelf 712 may provide a surface on which a user of the self-service retail market system 700 may place a retrieved inventory asset prior to, during, or after completing a transaction for the retrieved inventory asset. The shelf 712 may be formed in any number of ways, may have any number of different dimensions, and/or be made of any number of different materials.

As shown in FIGS. 7A and 7B, the asset transaction control device 702 may include a computing device 714, a scanning component 716, and a transaction device 718. The computing device 714 may be, be similar to, include, or be included in, the computing device 200 depicted in FIG. 2. The scanning component 716 may be configured to scan a bar code or similar marking affixed to an inventory asset. For example, a user of the self-service retail market system 700 may retrieve an inventory asset from a storage and/or display apparatus of a self-service retail market environment and scan the retrieved inventory asset using the scanning component 716. The scanning component 716 may be a fixed device or a moveable device. For example, the scanning component 716 may be a handheld scanning device that docks with, and/or is otherwise associated with, the computing device 714. The transaction device 718 may be configured to receive user input to facilitate a transaction and may be, be similar to, include, or be included in, a currency receiver, a card reader, and/or an RFID tag reader, among other examples.

The sensing device 704 may be or include one or more sensors as described above in connection with the sensing device 304 depicted in FIG. 3 and/or the sensing device 104 depicted in FIG. 1. The one or more sensors of the sensing device 704 may include a radar sensor, a LiDAR sensor, an optical proximity sensor, an inductive proximity sensor, an imaging device (e.g., a camera or a video camera), a pressure sensor and/or a thermal sensor, among other examples. For example, one or more sensors of the sensing device 704 may include a camera 720 for capturing images and/or video of a physical area in which the asset transaction control device 702 is located. In some examples, the camera 720 may be mounted on an arm assembly 722. The arm assembly 722 may include a proximal distal portion 724 and a proximal portion 726 coupled to the distal portion 724. The camera 720 may be disposed on the proximal portion 726, which may be positioned such that the camera 720 has a top view (e.g., a bird's-eye-view) of a scanning area 728. The scanning area 728 is an area in which an inventory asset may be scanned using the scanning component 716 to facilitate a transaction for the inventory asset. For example, as shown, the camera 720 may be positioned to receive image data associated with a field of view 730 that includes the scanning area 728.

In some examples, the sensing device 704 may include two or more cameras 720. Each of the two or more cameras 720 may be positioned such that the two or more cameras may have at least partially overlapping fields of view or non-overlapping fields of view. Any number of cameras 720 may be used to receive image data associated with any number of different respective fields of view. In some examples, the shelf 712 may be configured to facilitate image data quality. For example, the shelf 712 may have a color and/or material that is selected such that inventory assets in images captured by the sensing device 704 may be more readily identified by a computing device communicatively coupled with the sensing device 704. In some examples, the computing device 714 may be communicatively coupled with the sensing device 704 such that the sensing device 704 provides image data to the computing device 714, which processes the image data. In some examples, the sensing device 704 may be communicatively coupled with an additional computing device (e.g., a computing device housed within the stand assembly 706). The computing device coupled with the sensing device 704 (whether it be the computing device 714 and/or an additional computing device) may be configured to receive image data from the sensing device and to process the image data using an asset event manager such as, for example, the asset event manager 302 depicted in FIG. 3 and/or the asset event manager 126 depicted in FIG. 1. In this way, implementations of the self-service retail market system 700 may be configured to receive an indication (e.g., image data) associated with an asset conversion failure incident and generate an incident report corresponding to the asset conversion failure incident. The incident report may be provided to the asset transaction control device 702 and may be displayed on a screen thereof and/or may be transmitted to a user device associated with the user of the self-service retail market system 700.

In an illustrative example of under-ringing, as explained above in connection with FIG. 3, a user of the self-service retail market system 700 may retrieve a number of inventory assets from an inventory asset storage and/or display apparatus in the self-service retail market environment associated with the self-service retail market system 700. The user may carry the inventory assets to the self-service retail market system 700 and may scan one or more of the inventory assets using the scanning component 716. The user may fail to scan a retrieved inventory asset (e.g., by placing the inventory asset on the shelf 712 without scanning it and/or by covering the barcode of the inventory asset as it is passed by the scanning component 716), and image data containing images and/or video of the resulting asset conversion failure incident may be obtained using the one or more cameras 720 of the sensing device 704. The sensing device 704 may provide the image data to a computing device and an asset event manager associated with the computing device may detect the asset conversion failure incident based on the image data.

For example, the asset event manager may be, include, or be included in, a computer vision system that is configured to detect asset conversion failure incidents based on image data. In some implementations, for example, the computer vision system may include a machine learning model or other artificial intelligence model that is trained to detect the presence of an inventory asset in an image or video frame (hereinafter referred to as an image). In some examples, the computer vision system may be trained to recognize a potential scanning operation in which a user of the self-service retail market system 700 passes an inventory asset from left to right adjacent the scanning component 716 as a potential scanning operation. In some examples, the computer vision system may be trained to recognize a potential scanning operation in response to simply detecting an inventory asset in an image. In response to detecting a potential scanning operation, the asset event manager may increment a retrieved inventory asset counter by one. Thus, if the user scans two inventory assets and moves a third inventory asset adjacent the scanning component 716 without scanning it, the asset event manager may increment the scanned inventory asset counter by one three times to yield a total count of three. The asset event manager may be configured to compare the total count of the retrieved inventory asset counter (three) with a scanned inventory asset count provided by the scanning component 716 (e.g., via the computing device 714). Because the user may have only scanned two inventory assets, the scanned inventory asset count provided by the scanning component 716 may be equal to two (which is not equal to three). The asset event manager may detect an asset conversion failure incident responsive to the inequality between the retrieved inventory asset counter and the scanned inventory asset counter. In response to detecting the asset conversion failure incident, the asset event manager may cause an incident report to be generated. A representation associated with the incident report may be displayed by the computing device 714 and/or presented by a user device associated with the user of the self-service retail market system 700.

As indicated above, FIGS. 7A and 7B are provided as examples. Implementations of a self-service retail market system may differ from what is shown and described with respect to FIGS. 7A and 7B. For example, the system may include any number of different types of devices. In some examples, an asset event manager may be configured to obtain sensing information from a number of different sensing devices and may be configured to detect asset conversion failure incidents using any number of different types of machine learning or other artificial intelligence techniques. In some examples, the asset event manager may be continuously trained using new sensing data and labels associated with incident reports corresponding thereto. Any number of different combinations of the sensing devices, computing devices, and techniques for facilitating asset recovery as described herein are considered to be within the ambit of the present disclosure.

As described above in connection with FIGS. 1-7B, various implementations of the disclosure relate to asset recovery in self-service retail market environments. In some implementations, a user of the self-service retail market may retrieve one or more inventory assets from a storage and/or display apparatus of a self-service retail market environment and may neglect to complete a transaction for one or more of the retrieved inventory assets. For example, the user may retrieve three inventory assets from a display apparatus and may take the three inventory assets to an asset transaction control device located in the self-service retail market to initiate a transaction for one or more of the three inventory assets. If the user fails to complete a transaction for one or more of the inventory assets (e.g., by forgetting to initiate the transaction, by completing a transaction for some but not all of the retrieved inventory assets, or by initiating but failing to complete a transaction associated with one or more of the retrieved inventory assets), an asset event manager associated with the self-service retail market environment may detect an occurrence of an asset conversion failure incident. In response to detecting the occurrence of the asset conversion failure incident, the asset event manager may generate an incident report indicating the occurrence of the asset conversion failure incident and may provide that incident report to a user device associated with the user of the self-service retail market environment, an operator device associated with an operator of the self-service retail market environment, and/or an inventory management system associated with the self-service retail market environment. The incident report may be indicative of the occurrence of the asset conversion failure incident and may include inventory asset identification information and/or user identification information.

In some examples, based on receiving the incident report, the operator of the self-service retail market environment may initiate an asset recovery operation such as, for example, by causing the asset recovery component to transmit an incident report to a user device associated with the user. In some examples, the incident report received by a user device (e.g., from the asset recovery component and/or from the asset event manager) may include a selectable representation that, upon selection by the user, causes the asset recovery component to initiate an asset recovery operation. For example, the incident report may include a notification pushed to a mobile device used by the user. The notification may include a selectable button that, upon selection by the user, causes the user device to access a GUI provided by the asset recovery component. The GUI may be populated with information associated with the asset conversion failure incident and may include one or more interactive aspects that can be manipulated by the user to complete an asset recovery operation (e.g., a transaction) associated with the inventory asset corresponding to the asset conversion failure incident. In some examples, the incident report and/or an indication of completion of the asset recovery operation may be provided to the user device, an operator device, and/or an inventory management system, which may facilitate updating inventory records and/or user accounts in accordance with the asset recovery operation.

To further describe some implementations in greater detail, reference is next made to examples of techniques used by an asset recovery system. The techniques may be executed using one or more computing devices, such as included within or otherwise using the systems, software, and devices described with respect to FIGS. 1-7B. The techniques may be performed, for example, by executing computer-executable instructions such as routines, instructions, or programs described according to Java, JavaScript, C++, or other such routines or instructions. The steps, or operations, of the techniques or any other technique, method, process, or algorithm described in connection with implementations disclosed herein may be implemented directly in hardware, firmware, software executed by hardware, circuitry, or a combination thereof.

Although the techniques are each shown as a series of operations for clarity, implementations of those techniques or any other method, technique, process, and/or algorithm described in connection with the implementations disclosed herein can be performed in various orders and/or concurrently, unless a particular order of operation is specified herein. Additionally, operations in accordance with this disclosure may be performed with other operations not presented and described herein. Furthermore, one or more aspects of the systems and techniques described herein may be omitted.

FIG. 8 is a flowchart illustrating an example of a technique 800 for asset recovery in association with a self-service retail market environment. The example technique 800 is an example in which a computing device (e.g., a computing device of the service provider system 402 depicted in FIG. 4, the sensing device 404 depicted in FIG. 4, a computing device of the operator system 406 depicted in FIG. 4, the asset event manager 302 depicted in FIG. 3, the sensing device 304 depicted in FIG. 3, the asset transaction control device 306 depicted in FIG. 3, and/or the computing device 200 depicted in FIG. 2) performs operations associated with asset recovery. As shown by reference number 802, the technique 800 may include receiving an indication associated with an asset conversion failure incident. For example, the computing device (such as by using the asset event manager 302 depicted in FIG. 3) may receive an indication associated with an asset conversion failure incident, the asset conversion failure incident comprising a failure of a user of the self-service retail market environment to complete a transaction for a retrieved inventory asset, as described above in connection with FIG. 3. In some aspects, receiving the indication associated with the asset conversion failure incident may include receiving a communication from a sensing device, wherein the communication comprises the indication. In some aspects, receiving the indication associated with the asset conversion failure incident may include receiving a communication from an asset transaction control device, wherein the communication comprises the indication.

As shown by reference number 804, the technique 800 may include identifying the user based on the indication. For example, the computing device (such as by using the asset event manager 302 depicted in FIG. 3) may identify the user based on the indication associated with the asset conversion failure incident, as described above in connection with FIG. 3. In some aspects, identifying the user may include receiving user identification information and identifying the user based on the user identification information and a user database comprising a user record associated with the user. In some aspects, the user identification information may be associated with at least one of a user payment card, a user access device, or the user mobile device. In some aspects, the user identification information may include an image of the user, and identifying the user may include performing a facial recognition operation to identify the user based on the image of the user. In some aspects, the indication associated with the asset conversion failure incident may include the image of the user.

As shown by reference number 806, the technique 800 may include generating an incident report. For example, the computing device (such as by using the asset event manager 302 depicted in FIG. 3) may generate an incident report corresponding to the asset conversion failure incident, as described above in connection with FIG. 3.

As shown by reference number 808, the technique 800 may include transmitting the incident report. For example, the computing device (such as by using the asset event manager 302 depicted in FIG. 3) may transmit the incident report to a user mobile device associated with the user, the incident report comprising an asset recovery mechanism associated with an asset recovery operation, as described above in connection with FIG. 3.

As shown by reference number 810, the technique 800 may include receiving an indication of a user interaction with the asset recovery mechanism. For example, the computing device (such as by using the asset event manager 302 depicted in FIG. 3) may receive an indication of a user interaction with the asset recovery mechanism, as described above in connection with FIG. 3.

As shown by reference number 812, the technique 800 may include performing the asset recovery operation. For example, the computing device (such as by using the asset event manager 302 depicted in FIG. 3) may perform the asset recovery operation responsive to receiving the indication of the user interaction with the asset recovery mechanism, as described above in connection with FIG. 3.

The technique 800 may include additional aspects (e.g., additional operations and/or features), such as any single aspect or any combination of aspects described below or in connection with one or more other techniques described elsewhere herein.

In some aspects, the incident report may indicate a time period within which the asset recovery operation is to be performed. In some aspects, the technique 800 may further include receiving an operator input via an operator device, wherein the operator input is indicative of the time period. In some aspects, the technique 800 may further include detecting an expiration of a reminder delay timer and transmitting, based on the expiration of the reminder delay timer, a reminder communication to the user device. In some aspects, the technique 800 may further include receiving an operator input via an operator device, wherein the operator input is indicative of the reminder delay timer.

FIG. 9 is a flowchart illustrating an example of a technique 900 for asset recovery in association with a self-service retail market environment. The example technique 900 is an example in which a computing device (e.g., a computing device of the service provider system 402 depicted in FIG. 4, the sensing device 404 depicted in FIG. 4, a computing device of the operator system 406 depicted in FIG. 4, the asset event manager 302 depicted in FIG. 3, the sensing device 304 depicted in FIG. 3, the asset transaction control device 306 depicted in FIG. 3, and/or the computing device 200 depicted in FIG. 2) performs operations associated with asset recovery. As shown by reference number 902, the technique 900 may include receiving an indication associated with an asset conversion failure incident. For example, the computing device (such as by using the incident detection component 410 depicted in FIG. 4 and/or the asset event manager 302 depicted in FIG. 3) may receive an indication associated with an asset conversion failure incident, the asset conversion failure incident comprising a failure of a user of the self-service retail market environment to complete a transaction for a retrieved inventory asset, as described above in connection with FIGS. 3 and/or 4.

As shown by reference number 904, the technique 900 may include generating an incident report. For example, the computing device (such as by using the incident report component 412 depicted in FIG. 4, the incident report component 416 depicted in FIG. 4, and/or the asset event manager 302 depicted in FIG. 3) may generate an incident report corresponding to the asset conversion failure incident, as described above in connection with FIGS. 3 and/or 4.

As shown by reference number 906, the technique 900 may include transmitting the incident report. For example, the computing device (such as by using the incident report component 412 depicted in FIG. 4, the incident report component 416 depicted in FIG. 4, and/or the asset event manager 302 depicted in FIG. 3) may transmit the incident report, as described above in connection with FIGS. 3 and/or 4.

The technique 900 may include additional aspects (e.g., additional operations and/or features), such as any single aspect or any combination of aspects described below or in connection with one or more other techniques described elsewhere herein.

In some aspects, the technique 900 may further include determining an identity of a user associated with the asset conversion failure incident. In some aspects, transmitting the incident report may include transmitting the incident report to a user device associated with the user. In some aspects, the user device may include a mobile device. In some aspects, determining the identity of the user may include receiving, from a sensing device, user identification information and determining the identity of the user based on the user identification information. In some aspects, the incident report may include an asset recovery mechanism associated with an asset recovery operation.

FIG. 10 is a flowchart illustrating an example of a technique 1000 for asset recovery in association with a self-service retail market environment. The example technique 1000 is an example in which a computing device (e.g., a computing device of the service provider system 402 depicted in FIG. 4, the sensing device 404 depicted in FIG. 4, a computing device of the operator system 406 depicted in FIG. 4, the asset event manager 302 depicted in FIG. 3, the sensing device 304 depicted in FIG. 3, the asset transaction control device 306 depicted in FIG. 3, and/or the computing device 200 depicted in FIG. 2) performs operations associated with asset recovery. As shown by reference number 1002, the technique 1000 may include receiving an indication associated with an asset conversion failure incident. For example, the computing device (such as by using the incident detection component 410 depicted in FIG. 4 and/or the asset event manager 302 depicted in FIG. 3) may receive an indication associated with an asset conversion failure incident, the asset conversion failure incident comprising a failure of a user of the self-service retail market environment to complete a transaction for a retrieved inventory asset, as described above in connection with FIGS. 3 and/or 4.

As shown by reference number 1004, the technique 1000 may include identifying the user based on the indication. For example, the computing device (such as by using the user identification component 414 depicted in FIG. 4 and/or the asset event manager 302 depicted in FIG. 3) may identify the user based on the indication associated with the asset conversion failure incident, as described above in connection with FIGS. 3 and/or 4. In some aspects, identifying the user may include receiving user identification information and identifying the user based on the user identification information and a user database comprising a user record associated with the user. In some aspects, the user identification information may be associated with at least one of a user payment card, a user access device, or the user mobile device.

As shown by reference number 1006, the technique 1000 may include generating an incident report. For example, the computing device (such as by using the incident report component 412 depicted in FIG. 4, the incident report component 416 depicted in FIG. 4, and/or the asset event manager 302 depicted in FIG. 3) may generate an incident report corresponding to the asset conversion failure incident, as described above in connection with FIGS. 3 and/or 4.

As shown by reference number 1008, the technique 1000 may include transmitting the incident report. For example, the computing device (such as by using the incident report component 412 depicted in FIG. 4, the incident report component 416 depicted in FIG. 4, and/or the asset event manager 302 depicted in FIG. 3) may transmit the incident report to a user mobile device associated with the user, as described above in connection with FIGS. 3 and/or 4.

The technique 1000 may include additional aspects (e.g., additional operations and/or features), such as any single aspect or any combination of aspects described below or in connection with one or more other techniques described elsewhere herein.

The implementations of this disclosure can be described in terms of functional block components and various processing operations. Such functional block components can be realized by any number of hardware and/or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, JavaScript, assembler, or the like, with the various algorithms being implemented with any combination of data structures, objects, processes, routines, or other programming elements.

Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “mechanism,” “module,” or “monitor” as used herein and in the figures may be understood as corresponding to a functional unit implemented using software, hardware (e.g., an integrated circuit, such as an application-specific integrated circuit (ASIC)), or a combination of software and hardware. In certain contexts, such mechanisms, modules, or monitors may be understood to be a processor-implemented software mechanism, processor-implemented software module, or software-implemented monitor that is part of or callable by an executable program, which may itself be wholly or partly composed of such linked mechanisms, modules, or monitors.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While this disclosure has been described in connection with certain implementations, it is to be understood that this disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for asset recovery in association with a self-service retail market environment, the apparatus comprising:
a memory;
a processor coupled with the memory and configured to cause the apparatus to:
receive an indication associated with an asset conversion failure incident, the asset conversion failure incident comprising a failure of a user of the self-service retail market environment to complete a transaction for a retrieved inventory asset;
identify the user based on the indication associated with the asset conversion failure incident;
generate an incident report corresponding to the asset conversion failure incident;
transmit the incident report to a user mobile device associated with the user, the incident report comprising an asset recovery mechanism associated with an asset recovery operation;
receive an indication of a user interaction with the asset recovery mechanism; and
perform the asset recovery operation responsive to receiving the indication of the user interaction with the asset recovery mechanism.

2. The apparatus of claim 1, wherein the processor, to cause the apparatus to receive the indication associated with the asset conversion failure incident, is configured to cause the apparatus to receive a communication from a sensing device, wherein the communication comprises the indication.

3. The apparatus of claim 2, wherein the processor, to cause the apparatus to receive the indication associated with the asset conversion failure incident, is configured to cause the apparatus to receive a communication from an asset transaction control device, wherein the communication comprises the indication.

4. The apparatus of claim 1, wherein the processor, to cause the apparatus to identify the user, is configured to cause the apparatus to:
receive user identification information; and
identify the user based on the user identification information and a user database comprising a user record associated with the user.

5. The apparatus of claim 4, wherein the user identification information is associated with at least one of a user payment card, a user access device, or the user mobile device.

6. The apparatus of claim 4, wherein the user identification information comprises an image of the user, and wherein the processor, to cause the apparatus to identify the user, is configured to cause the apparatus to perform a facial recognition operation to identify the user based on the image of the user.

7. The apparatus of claim 6, wherein the indication associated with the asset conversion failure incident comprises the image of the user.

8. The apparatus of claim 1, wherein the incident report indicates a time period within which the asset recovery operation is to be performed.

9. The apparatus of claim 8, wherein the processor is further configured to cause the apparatus to receive an operator input via an operator device, wherein the operator input is indicative of the time period.

10. The apparatus of claim 1, wherein the processor is further configured to cause the apparatus to:
detect an expiration of a reminder delay timer; and
transmit, based on the expiration of the reminder delay timer, a reminder communication to the user device.

11. The apparatus of claim 10, wherein the processor is further configured to cause the apparatus to receive an operator input via an operator device, wherein the operator input is indicative of the reminder delay timer.

12. An apparatus for asset recovery in association with a self-service retail market environment, the apparatus comprising:
a memory;
a processor coupled with the memory and configured to cause the apparatus to:
receive an indication associated with an asset conversion failure incident, the asset conversion failure incident comprising a failure of a user of the self-service retail market environment to complete a transaction for a retrieved inventory asset;
generate an incident report corresponding to the asset conversion failure incident; and
transmit the incident report.

13. The apparatus of claim 12, wherein the processor is further configured to cause the apparatus to determine an identity of a user associated with the asset conversion failure incident.

14. The apparatus of claim 13, wherein the processor, to cause the apparatus to transmit the incident report, is configured to cause the apparatus to transmit the incident report to a user device associated with the user.

15. The apparatus of claim 14, wherein the user device comprises a mobile device.

16. The apparatus of claim 13, wherein the processor, to cause the apparatus to determine the identity of the user, is configured to cause the apparatus to:
receive, from a sensing device, user identification information; and
determine the identity of the user based on the user identification information.

17. The apparatus of claim 12, wherein the incident report comprises an asset recovery mechanism associated with an asset recovery operation.

18. An apparatus for asset recovery in association with a self-service retail market environment, the apparatus comprising:
a memory;
a processor coupled with the memory and configured to cause the apparatus to:
receive an indication associated with an asset conversion failure incident, the asset conversion failure incident comprising a failure of a user of the self-service retail market environment to complete a transaction for a retrieved inventory asset;
identify the user based on the indication associated with the asset conversion failure incident;
generate an incident report corresponding to the asset conversion failure incident; and
transmit the incident report to a user mobile device associated with the user.

19. The apparatus of claim 18, wherein the processor, to cause the apparatus to identify the user, is configured to cause the apparatus to:
receive user identification information; and
identify the user based on the user identification information and a user database comprising a user record associated with the user.

20. The apparatus of claim 19, wherein the user identification information is associated with at least one of a user payment card, a user access device, or the user mobile device.
